(19) United States
(12) Patent Application Publication
(10) Pub. No.: US 2011/0117903 A1
(43) Pub. Date: May 19, 2011

(54) DEVICE AND METHOD FOR DISABLING MOBILE DEVICES

(76) Inventor: James Roy Bradley, Carp (CA)

(21) Appl. No.: 12/950,446

(22) Filed: Nov. 19, 2010

Related U.S. Application Data
(60) Provisional application No. 61/262,646, filed on Nov. 19, 2009.

(51) Int. Cl. G06F 15/00; H04W 4/04; G01P 15/00; G01P 3/00

(52) U.S. Cl. 455/418; 702/142; 702/141; 702/150

(57) ABSTRACT

An arrangement for disabling suitably equipped mobile devices senses at least one of: acceleration, jerk, velocity, position, orientation relative to a vehicle location trend, and orientation of a direction of motion. Position and orientation sensing elements are becoming increasingly prevalent in mobile devices, be they cell phones, smart phones, portable Internet devices, portable wireless devices, mobile Internet devices, Portable Navigation Devices (PND), iPhones, tablet computers, iPads, or Portable Digital Assistants (PDA). Although the operation of which while driving is illegal in many jurisdictions, mobile devices continue to be used by drivers of motor vehicles. Common perception is that it is dangerous to divide one's attention to activities other than the task of operating motor vehicles, while driving. The present invention discloses a device and method of exploiting intricacies of vehicle movement trends by processing to sufficient fidelity as to permit extraction an indication of location with respect to vehicle, of a navigating portable wireless device and temporarily disable. The disclosure teaches use of at least one of: acceleration, jerk, velocity with sufficient fidelity, and differentiation of position updates with sufficient fidelity.

### BACKGROUND OF THE INVENTION

1. Field of the Invention

The present invention relates to cell phones, portable wireless devices, portable Internet devices, in-vehicle electronics, smart phones, mobile navigation devices, portable digital assistants, tablet computers, and personal navigation devices.

2. Description of the Related Art

Cell phone use, although outlawed in many jurisdictions, continues to be a contributing factor in motor vehicle accidents. Attempts have been made to identify cell phone use while driving although none of the above cell phone inhibiting functions expressly isolate the operator's area in the vehicle, without expressly equipping the vehicle with additional hardware. The present disclosure benefits from one of a set of refined user equipment velocity measurements, as well as orientation measurements permitting resolution of the user location vis-à-vis the vehicle without additional hardware, exploiting simple suppositions. For cases wherein no additional network parameter is passed, the assumption that portable wireless device, (herein forward being taken to mean, cell phone, smart phone, portable digital assistant, portable navigation device, IEEE 802.11, IEEE 802.16, WiFi device, WiMax device, portable internet device, mobile Internet device, wireless communication device, portable computer, tablet computer, iPhone, iPad, laptop) sold in countries that drive on the right hand side of the road almost always have the operator's station on the left hand side of the vehicle and vice versa for jurisdictions that drive on the left hand side of the road.

There is economic pressure by cell phone operators to not inhibit moving cell phone users, for fear of losing legitimate wireless business from vehicle passengers. There is pressure on the cell phone manufacturers not to require a change in infrastructure for such technology.

University of Utah Wally Curry and Xuesong Zhou of the University of Utah have developed a key fob called Key2safedriving.com technology, Curry explains the use of technology to disable cell phone use whilst in motion using a Bluetooth link to a key fob. See also:

Armatys, M., et al. “Demonstration of Decimeter-Level Real-Time Positioning of an Airborne Platform”, Proc. of the Institute of Navigation National Technical Meeting, Anaheim, Calif., January 2003

Grewal, Mohinder S. et al. GPS Inertial Navigation, and Integration Wiley, 2^{nd} Edition, Hoboken, New Jersey, 2007

Natarajan, Hariharan Master's Thesis Florida State University, Florida, 2004

Hurn, Jeff, GPS, A guide to the Next Utility, Trimble Navigation Ltd, P.O. Box 3642, 645 North Mary Avenue, Sunnyvale Calif., 1989

Ezal, Kenan et al. Compact single-aperture antenna and Navigation System, WIPO patent application

Elliot D. Kaplan, and Chris Hegarty, Understanding GPS Principles and Applications, Second Edition, Artech House Publishers, 2006

Lyon, G. F. et al. Ionospheric Effects on Space Application Systems, Journal of the Canadian Aeronautics and Space Institute, ISSN 0008-2821, CASI, 79 Sparks Street Ottawa, Canada, December 1983

GPS uses several satellites, nominally 4 satellites in each of 6 orbital planes, and some spares that are maintained and controlled by the US military. The system originally called the GPSS for Global Positioning Satellite System has evolved the moniker to be a subset of GNSS, or Global Navigation Satellite System as it picks up the various parts of BAIDOU (northern reference), European also Geo-stationary Navigation Overlay System (EGNOS), GPS And GEO Augmented Navigation (GAGAN), GALILEO, Global Orbiting Navigation Satellite System (GLONASS), Local Area Augmentation System (LAAS), and Wide Area Augmentation System (WAAS), as well as, pseudo-lites, all of which assist and refine the GPS resolution and reliability.

We will restrict our discussion to GPS, although various aspects of the discussion apply equally well to GNSS. GPS navigation, resolves two tasks: it resolves the GPS user's position with respect to the satellite constellation into pseudo ranges, and it further processes these pseudo ranges into time as well as a geo-spatial location, i.e., latitude and longitude.

Processing Received GPS Signal into Pseudo Ranges

Each satellite vehicle, (SV), of the GPS satellite system has a unique discrete sequence code it transmits.

The user's GPS receiver receives essentially this ˜2 MHz BW signal at 1575.62 MHz and typically once converted to base-band, attempts to correlate this received signal against a set of known acceptable code sequences simulated in the receiver. These simulated code sequences must be tried with different phases. As the satellite is either approaching, receding from, or passing the user, the nominal center frequency, will in general, be altered by an added Doppler shift. The Doppler shift of an approaching SV can be up to 5 KHz above/below the nominal SV transmission frequency.

With the occasional addition of these small time slices the sliding correlator, as it is referred to in the industry, will eventually step through all of the possible incoming code time offsets. At the point of maximum alignment of the incoming signal code with that of the sliding correlator, determined by measuring a maximum at the output of the sliding correlator, the circuitry discontinues the process of stepping through the code offsets (or acquisition) and maintains a simulated code generation that is essentially time aligned (or tracking). There is a minor exception that, depending on implementation; there might be a slight shift by either a chip or a fraction of a chip to maintain lock. Simulated code generation remains essentially lined up with the incoming received signal.

De-spreading of the signal from any SV decreases the effective bandwidth and when aligned to the SV's replica code offers an indication of code phase. Code phase comparisons of additional SV's permit the receiver an indication of the users position relative to the SV pair. The locus of possible positions is a hyperbola of position.

Subject to geometric restrictions, two such hyperbolae of position yield a ‘loci of position’ upon which the user is deduced to be. Using the assumption that the receiver is on the earth's surface, a third hyperbolae of position, or a very accurate reference clock permits a three dimensional position to be deduced.

Typical receivers use code correlation branches or by time multiplexing the code correlation branches, deduce time offsets, referred to as code phase, and because each SV transmits at very close to the same time, the code phases represent the time of flight of signal from the various SV's to the receiver. The confluence resultant ‘pseudo ranges’ from the SV's are distilled into a small volume of possible user location. This is based on the signal being correlated against that of the simulated code sequence using the clock from the signal simulated in the sliding correlator. Dithering the phase of the correlator clock back or forward until the volume of the solutions from the various Satellite Vehicles is minimized further refines the estimate of position. [Hurn, 1990]

Alternate embodiments use a very accurate reference of time to reduce the number of satellite signals needed by one. Likewise the assumption of receiver location on the earth's surface serves to reduce the number of SV's required to have a position fix, as the time reference compared to the SV time yields an estimate of ‘time of flight’ of the signal, which is translatable into distance from the SV using the velocity of light, c.

Encoded upon the signal from the SV is a data channel with information pertaining to the SV orbital elements, with respect to earth and sidereal entities. Using knowledge of SV position, and distance from the respective SV's a calculation of the receiver position, or velocity is performed from these elements, a technique known to anyone of ordinary skill in the art.

Older GPS satellites transmit on two user frequencies. Newer GPS satellites transmit on three user frequencies. Both old and new satellites transmit on both the L1 and L2 nominal frequencies at 1575.42 MHz and 1227.6 MHz. Civilian users without detailed knowledge of the L2 signal are able to resolve certain details of the L2 signal, but are typically unable to resolve the code information of the L2 signal.

The L2 signal is modulated at a much faster code chipping rate permitting acquisition and tracking to a much finer time resolution (time resolutions approx ten times better, than the L1 signal permits.

Civilian users are typically able to determine information about the RF phase of the L2 signal and as a result time of flight comparison is possible. Unfortunately the RF phase relationship as the L1/L2 signal pair leaves the satellite, remains unknown to civilian users.

The difference between this signal (the L2 band) and the initial signal discussed (the L1 band signal), permits removal of the Ionospheric effects as the difference in the time of flight of both signals offers a difference in path length from the SV. Both signals take a slightly longer path than direct. The amount depends on frequency. Because the amount of this effect based on frequency, and the two frequencies are known, the direct path length is deduced. Because the L2 signal is much larger in BW than the L1, the signal offers a refined ability to resolve the pseudo range from this SV. [Lyon, G 1983].

Users able to decode the L2 code signal exploit the larger bandwidth (BW) of the military pseudo-random code which permits a code correlation to take place at a much faster chip rate (ten times as fast) and de-spreads to a much narrower BW. Measurement of the L2 code phase time offset of maximum output correlation is measured to a much finer degree as the time is given with much higher resolution.

Knowledge of the L1 to L2 phase relationship, known to military users, permits knowledge of the P code phase, permitting increased time resolution which are translated to finer position resolution. Resolution of the phase epoch (i.e. the point in time of known phase relationship between the two signals), permits enhanced position resolution. Prior to such refined location resolution, processing to remove the Doppler created by the motion of the satellite to the user, is done by adjusting the received signal down converter local oscillator, to have the signal downshifted direct conversion to zero intermediate frequency, IF, or to a suitable above zero IF where the negative frequency image is filtered prior to use, known to those familiar with the art.

An alternative method of resolving this is to use an indication of the frequency, deduced by an initial processing path, such as above or some combination thereof, and then in a parallel RF channel to receive the signal coherently and then resolve the issues of code phase as post processing. This offers a much preferred method at the expense of front end signal to noise ratio attained, and deliberate non-exploitation of the inherent resilience to noise or interference, such as multi-path, which the use of dispreading and its inherent processing gain allows in exchange for a much refined signal permitting direct RF phase extraction for very fine position resolution.

In other embodiments, the signal is treated as an incoming analog signal, received, amplified, digitized and post processed to resolve the position.

Satellite signals transmitted from space at other than the receiver's zenith undergo bending as the signals transit the ionosphere. This has the effect of making the path from the satellite to the receiver longer than the direct line of sight. The effect is mitigated by using satellite data from the transmitted data stream in conjunction with the relative locations for the satellite and user. Differential GPS uses signals transmitting from a fixed reference receiver indicative of the position the fixed receiver senses. This transmitted information is subtracted from the users receiver to resolve the difference in position from the fixed receiver to the user's receiver. To a first order the effects from the ionosphere, troposphere, and timing etc., are removed.

Sophisticated GPS receivers receive this information also. The position of the differential receiver is subtracted from the signal received by the user offering a refined location in reference to the Differential receiver usually in a highly refined known location. It is usual to then add in this highly refined known position with the now much enhanced difference in position from the (differential) receiver to the user's receiver. Some differential receivers are termed Pseudo-lites, (short for pseudo-satellite), i.e. they broadcast information to the User's GPS receiver. Some of these signals are generated by the infrastructure itself, termed WAAS, for Wide Area Augmentation System, supplying essentially a clock from a geo-stationary orbit. This is referred to as a Space Based Augmentation System or SBAS. There exists a land based system that is at a much more local level, but the reference to the location of this Local Area Augmentation System or LAAS, is much more cogent.

Numerous attempts to disable cell phones have made, none have sufficiently refined the use of commonly available signals from GNSS, GPS, GLONASS, BAIDOU, GALILEO, EGNOS, GAGAN, or similar navigation systems to be usable.

A further refinement of the position is done by using the two L1 and L2 signals and in knowing a priori that there is a delay in each of the satellite signal paths associated with the bend in the path caused by Faraday rotation as it passes charged layers of the ionosphere (See Lyons, G. the [resulting] delay of the signal which is inversely proportional to velocity squared as explained in [GPS guide to the next Utility, by Jeff Hum, 1989]

Other signal channels that are available include the L2C band, the L5 band, any of the EGNOS, BAIDOU, GLONASS, and GAGAN, channels that are refined and used.

Although the inertial of a vehicle remains essentially constant over short intervals, classical differentials permit the smooth movement of vehicles during cornering motion. A differential shown in FIG. 1, is driven by the main drive shaft. The drive shaft inputs a torque to the differential resulting in movement of the drive wheels via the half shafts. Provided the two (or sometimes four in FWD, or AWD vehicles), are in contact with the road surface, the applied torque results in motion of the combined output shafts. The shafts rotate at essentially the same rate for straight movement of the vehicle (differing only by the ratio of associated wheel radii). Cornering motion results in the half shaft associated with the wheel on the inner side of the corner turning at a slower speed, thereby permitting the smooth, un-skipping motion of both drive wheels of the vehicle. Application of torque of constant rotation of the drive shaft results in vehicle speeds that are essentially constant.

Front wheel drive vehicles that have a motor in the front, have split shafts that apply power to their respective (right and left) wheels. The front wheel drive vehicle operates in essentially the same way that a rear wheel vehicle does, again the motion is essentially that of constant speed for constant speed inputs.

These two differential arrangements are all but universally adopted. The variations of the above are the cases of limited slip differential and poli-traction wherein the amount of slip is reduced, to zero in the case of posi-traction. Regardless of the above arrangement the motion of the vehicle is at least over a short interval constant, particularly concerning forward linear motion in reference to a point located approximately center on the drive axle, or essentially mid point between half axles on split axle driven vehicles.

See also patent applications: US20020070852, US20030096593, US20030176962, US20050045398, US20050255874, US20060148490, US20090164067, as well as patents U.S. Pat. No. 4,223,375, U.S. Pat. No. 4,545,019, U.S. Pat. No. 5,928,309, U.S. Pat. No. 6,256,558, and U.S. Pat. No. 6,502,035.

### SUMMARY OF THE INVENTION

In accordance with the illustrative embodiments demonstrating features and advantages of the present invention, there is provided an arrangement for inhibiting portable wireless device (e.g., Cell Phone, etc.) services when detected to be proximal to vehicle operator stations based on portable wireless device proximity to the vehicle operator's station.

The arrangement exploits portable wireless device navigation features. The arrangement provides for a processor coupled to the navigation/orientation sensors for detecting a preponderance of motion indicative of proximity to vehicle front and operator's side of vehicle.

The invention provides for a running average to be calculated wherein instances deemed to be forward are accumulated. Said number of forward instances being optionally reduced by the number of instances deemed to be rear of vehicle can be overall designated as forward provided it exceeds the number of rearward instances by a device configuration threshold parameter. The invention provides for running average to be calculated wherein instances deemed to be operator's side are accumulated. Said number of operator's side instances being reduced by the number of instances deemed to be non-operator side of vehicle can be designated as overall operators side provided it exceeds the number of non-operator side instances by a device configuration threshold parameter.

The location of portable wireless devices, equipped for navigation, is identified proximal to the operator's station by extracting the characteristics of motion indicative of such, and inhibiting at least some functionality. An optional device modification precludes hands-free use above a threshold speed, which is optionally set to that of a brisk walk.

Additionally the device and method presently described permit restitution of services for use in other than the operator's position. Optionally this is restricted wherein users must be using portable devices using non hands-free services. The present device isolates the operator location and exploits the steadiness of motion of other means of transport such as train, ship, and commercial jetliner to rescind what would otherwise be an inhibition. In another embodiment the device and method permit a statistical assessment to enhance one of velocity and orientation determination (azimuthally) permitting mobile device disabling based on location in the vehicle cabin.

Processing of information for this purpose issues from at least one of several sources: subtle changes in the position compared to an average position, subtle changes in orientation compared to average orientation, a combination of both, and enhanced navigation determination, i.e. such as DGPS. Location data in this case, although it can be, it is not restricted to being location data essentially obtained from two receivers disparately located, but optionally uses at least one of: the present differences to previously obtained location data, the subsequent differences to previously obtained location data.

The location is refined by massaging the data in at least one of: average the position and divide by a plurality of cases, using real time kinematical data, (RTK—wheel spin, steering direction etc.), e.g., GPS augmented with either an: attitude heading reference system (AHRS) (see Rockwell Collins Radio, Cedar Rapids Iowa), using Network RTK data, SBAS (Satellite Based Augmentation System), WAAS (Wide Area Augmentation System), LAAS (Local Area Augmentation System), etc.

Other optional techniques for motion resolution include using the other satellite channels, L2c or L5, from the GPSS, or any of the other signals from EGNOS, GLONASS, GAGAN, BAIDOU, or the like.

One such technique measures carrier phase by sampling the phase of the reference oscillator of the carrier-tracking loop. Another technique uses the difference of two carrier frequencies as a virtual carrier frequency to spread out phase ambiguities to permit their resolution by a simpler setup.

Although information from radio-navigation systems, or similar system permit resolution of position to centimeter level, and this is optionally exploited by this disclosure, it is noted that alternative methods merely ascertain a rough estimate of relative position and then exploit the refined RF phase measurement in any of its embodiments to further resolve acceleration, optionally via velocity time derivatives.

To ascertain location proximal to the operator's station the present disclosure resolves the location in the left hand side/right hand side, and the location in the fore/aft sense. Examples of left side/right side (LS/RS) operation determinations, consist of using a long term average of position compared to values of velocity of a more instantaneous nature, comparing the velocities of vehicle locations proximal to the operators station, left hand front of the vehicle in North America and Right hand front side of the vehicle in the UK and many commonwealth, as well as formerly, commonwealth countries. It is an aspect of the present disclosure to, by option, upon detection of a network parameter, e.g. North America, to be used in the determination of the question of Left Hand Drive, (like North America), or a predominantly Right Hand Drive Location. It is an aspect of the present disclosure to, by option, upon not detecting such network parameter to inhibit the device whilst in motion indicative of being used proximal to the operator's station.

As an exemplary case, consider initial motion of a vehicle at cruising speeds on a highway with turns both left and right occurring from time to time, constrained by cruise control wherein the average speed of the vehicle is sensed by the number of rotations of the drive shaft. In such case a navigation capable mobile device located on the left side of the motor vehicle equipped with a standard (meaning open, limited slip, or selectable (provided not selected presently)) differential, during turns to the right will travel slightly faster than the average vehicle speed as the mobile device travels a slightly larger arc per unit time. The direction of turn to the right is also deduced from the change in direction of the (unit) velocity vector determined by subtracting the previous position from the present. As the vehicle is under cruise control, the average speed of the vehicle is constant and remains at that of the vehicle during a previous condition other than turning, (to the right in this case). In particular, a mobile device located on the left side of the motor vehicle will undergo displacement acceleration during the operator (human or otherwise) input of steering commands. For the example mentioned the acceleration will be in the positive velocity direction. For left turns acceleration experienced at the beginning of the turn will be in the negative velocity direction, as will be explained later. Although the vehicle in this example is under cruise control, an essentially similar effect is apparent for a vehicle wherein the operator solely controls speed.

It is an exemplary embodiment wherein the speed of the vehicle is sampled for several intervals of time afterward to discern that the assumption of the vehicle making the average speed is a good one, and filtering on such corollary observation.

Essentially straight motion is resolved from turning motion. A significant salient in the speed profile occurs at the point of initiation of turn, or at the end of the turn. In particular navigational outputs are monitored, filtered and checked for such accelerations at these locations. Whether the turn is to the right or left is ascertained from one of: the navigational data stream, the change in orientation of the user's equipment.

Although certain mobile devices lack refined navigational solutions, the left hand side of a vehicle is able to be resolved from the center and right by at least one of: accumulating the results from a sizable sample space, having a navigational sensor arrangement sensitive to such motion, having a navigational sensor sensitive to velocity of such motion, wherein the motion is detected and assessed, or at least partially acquired previously and subsequently assessed and acted upon, including at least partially inhibiting a portable wireless device.

The subject of this disclosure measures examples, makes a determination, and deduces whether or not the mobile device is located on the left side of the vehicle. A determination of mobile device location on the operator's side of the vehicle is optionally disabled or relegated to hands free use by mobile device, commonly a cell phone, by internal switching in the cell phone. In this embodiment the restriction is rescinded once the navigation element in the mobile device detects a return to a lower velocity state, wherein inhibited services are, e.g., communications activity, messaging capability or ringer use is switched back to on. The arrangement optionally informs the user.

In other embodiments, the user equipment disables use of at least one of: hands-free use, use by wireless, e.g. Bluetooth, speakerphone, use in conjunction with the vehicle's data system, such as Wifi, WiMax, optical data link, or otherwise for cases of detected use during motion. This is to optionally prevent a vehicle operator from placing the unit on a passenger seat and using the device by headset while in motion.

In another embodiment, a necessary condition, although not sufficient to deduce mobile device operation during motorized vehicle use, wherein comparisons are made between the average speed of the vehicle and the instantaneous speed differences from average is exploited to make a determination of use, or intended use aboard larger vehicles wherein, on the balance of probability the user is a passenger, e.g., train, e.g., plane, e.g., ship.

It is understood that once processed, raw GPS signal, offers resolution of repeatability to so many meters. Processed signal is sufficiently resolved in most portable GPS receivers to be able to resolve relative distances of so many cm. As the technology matures, the resolution is becoming increasingly fine. The optional ability to average position and make determinations based on such works sufficiently well for location resolutions larger than a few cm.

Some radio-navigation sensors don't output finely resolved position. For navigation sensors of this type provided the latitude and longitude outputs are consistent, even if only so for short intervals, it will be appreciated that the position resolved will not always fall between the two locations of vehicle center of rotation (to be discussed later) and the operator's presumed location use, or of intended use and consequently not normally register in the accumulation of data of such. It is also appreciated that regardless of the resolution of the lat/long data, provided the navigation sensor is consistent, even if only over a short interval of time, that data will for these other cases fall, at least occasionally, fall between the locations of the center of rotation, and the operator's location offering a resolvable difference in speed, of the correct polarity for accumulation and usage for inhibiting a plurality of portable wireless device services. Referring to FIG. 5, we see vehicle initial position, 510, with center of rotation Y, 520, and operator position X, 530, from time to time the line of position, in this case, latitude or longitude, cannot be resolved, although because both locations are on one side of the line of position, a contribution of this location will typically not degrade the relative positional information accumulation significantly. In some cases, however, the line of position will be between the locations, such as shown at X′ and Y′. In this case the contribution to the running average will assist in resolving the difference in locations X′ and Y′. The system accumulates instances wherein both locations are considered to be the same, due to lat/long truncation to so many significant digits. It also accumulates cases wherein the location resolves to between these two. The system further de-accumulates for cases wherein they are considered to be detrimental to the attribution of the portable device being at the operator's position per event and consequently resolves the location in the vehicle left/right. In this embodiment, pluralities of instances are used to discern such. The minimum number of which is optionally selected and perhaps as low as one. In one embodiment of the present disclosure, the disabling functionality works in reverse such that cell phones from the UK are disabled for vehicle locations wherein operator's positions are detected to be on the right side of the vehicle.

As it is spoken about elsewhere in the disclosure, one other embodiment of the present disclosure has the location in the vehicle in the fore/aft sense, resolved by comparing the onset of g to the onset of direction change, it also resolves the position in the vehicle fore/aft by determining the lateral accelerations (determinable by comparing the accelerations at ˜90 degrees to the direction of travel), and determining the amount of acceleration. Cases greater than a certain lateral acceleration are attributed to being in the front seat of the vehicle. This will be explained in more detail later.

In one embodiment of the present disclosure, the disabling functionality is integral to the network. In one embodiment of the present disclosure the disabling function is used at any time when the mobile device is in motion regardless of the vehicle location.

In other embodiments the mobile device, if used in other than the operator's location, have only the voice functionality disabled while in motion, i.e. messaging still permitted provided the user is not the motor vehicle operator.

Fore/aft position is deduced by using at least one of: a measure of lateral acceleration beyond a threshold, a measure of lateral acceleration beyond a threshold, said threshold being a function of velocity, a measure of heading during a turn, to be explained shortly, a measure of acceleration determined by post processing to have been other than collinear with the radius of turn, derived from post processing analysis, a measure of the evenness of acceleration during a turn.

Gyroscopes (gyros for short) have been in the service of mankind since discovery by Hermann Anschutz-Kaempfe in 1908. The orientation entity aspect of the navigation and orientation entity, in this context will be taken to mean any combination of gyros, LASER ring gyros, Coriolis Gyros, Fiber Optic Gyro, Rotational Variable Coriolis Gyro (RVCG), differentially mounted INU's, a fluxgate, a magnetic compass, a magnetic fluxgate compass, differential radio navigation, differential GNSS signal using a plurality of signal sensing device(s) [antennae], deducing an indication of orientation by differential sensing, such as phase comparison of incoming network signal, e.g., a change in the different channels of WiMax.

Gyros are now available in miniature form including a common solid-state tuning fork gyro. A typical tuning fork gyro exploits a weak pressure sensing element in one of the tuning fork legs. In some embodiments the orientation-sensing element is a tuning fork element changing pitch or vibratory mode when undergoing changes in orientation. By sensing the pressure on the weak element rotation about the longitudinal axis of the tuning fork is determined. Vibration of the tuning fork, sensed, e.g., acoustically and resolved into frequency offers an indication of rate of turn about the tuning forks main axis. Multiple such tuning forks oriented at certain angles with respect to each other, permit determination of any rotation, although not the polarity. The usual orientation is orthogonal. Small accelerometers located a distance away from the axis of the tuning fork with a fixed location with respect to the axis permit determination of the polarity of the acceleration. See FIG. 4.

Certain mobile devices come equipped with orientation subsystems, such as: magnetic compasses, gyro-compasses, gyros or gyro systems. It is an option of this disclosure to exploit such systems, an alternative embodiment to add an accelerometer to exploit this change in orientation, an alternative embodiment to add both accelerometers and gyro, where not already present.

It is an option of the present disclosure to have processor, 416, of FIG. 3, determine the accelerations of the gyro and have them available for other processing elements (be they CPU or alternate Processing Unit) of the mobile element.

Portable wireless devices suitably equipped discern between rapid onset of rotation accompanied with essentially instantaneous onset of acceleration such as in the front seat of a motor vehicle or the rapid onset of rotation, accompanied only by a unidirectional acceleration (i.e. essentially only towards the center of the turn), such as would be witnessed in the back seat of a motor vehicle.

It is an aspect of the present disclosure to compare the onset of acceleration to the deduced heading change and make an assessment of whether front seat or not.

It is an aspect of the present disclosure that a threshold between the two is used to discern front seat locations and essentially rear seat positions located essentially over the rear set of wheels.

It is an aspect of this disclosure, to discern lateral acceleration levels (compared to an indication of direction of motion as determined by navigational entity) and deduce that lateral accelerations above a certain level are assumed to be in the front seat and lateral accelerations below a certain threshold are assumed to be back seat, although these are not required to be directly over the rear wheels to be identified as such.

The arrangement uses both left/right and fore/aft together.

It is an aspect of the present disclosure to exploit both the of the above determinations i.e. front seat, operators position to deduce and inhibit reception of calls, or mobile element use based on the assumption that the mobile entity is located in the operators possession. It is an aspect of the present disclosure to disable the unit, (in conjunction with the above restrictions as appropriate) if it is determined that the mobile unit is located in the center of the vehicle.

It is an aspect of the present disclosure that the threshold of the number of successful ascertainments of that the mobile device is with the operator is filtered with removal of the number of unsuccessful ascertainments. It is an aspect of the present disclosure wherein the acceleration of a non-straight roadway segment vs. a straight segment is ascertained exploiting accelerometer outputs internal to the mobile device.

It is an aspect of the present disclosure that the acceleration profiles are determined based on template matching essentially of planar motion. It is an aspect of the present disclosure wherein the comparison is partially determined by accelerations and partially by signals representing other motion.

It is an aspect of the present disclosure that the unit is usable at much lower speeds than just cruise speeds.

It is an aspect of the present disclosure that the unit is usable with much more refined navigation systems and compared to location in the lane of a given roadway.

It is an aspect of the present disclosure that this is integral to the mobile device.

Wherein the value of measurements is an optional value settable by network or otherwise.

It is an aspect of the present disclosure that the present device and method inhibition mechanism is network selectable over the air.

It is an aspect of the present disclosure to sense the difference between longer right and left hand turns of essentially constant radius and determine the effect of different radii of the left and right drive wheels, due to differences in wear, and tire pressure. In typical circumstances this effect is not great, but leads to a tiny displacement of the center of rotation (in plan form sense), from the center of the vehicle rear axle.

It is an optional aspect of this disclosure that the vehicle is determined to be traveling in an accelerating frame of reference prior to the present.

### Left/Right Determination by Velocities—Alternate Means

It is an embodiment of the present disclosure that the velocity detected by the device is done so by using pseudo velocities from the various satellites, at least one of the: predicted paths of which, the predicted velocities of which, are used to determine the velocities in the ‘alternate means’. The alternate velocity determination done by predicted position is achieved by extracting the instantaneous predicted positions by extrapolating the pseudo ranges to present. Acceleration information is determined from the time profile the synchronized position of the incoming data stream from the various SV's and determining the corresponding accelerations extant as a result of such. Alternatively an estimate of the Doppler shift is extrapolated from the stream of Doppler shifts presently available. Using this estimation, the data is received at incoming frequencies, shifted to zero IF, and de-spread to resolve the remaining coarse acquisition data stream epochs profiles, thereby offering an indication of acceleration, and using such to make a determination that the most plausible location in a vehicle of use, or intended use of a portable wireless device is proximal to an operator's location and consequently inhibit at least partially wireless services.

In an optional embodiment, velocity data is determined in a similar manner and resolved to make a determination of location of use, or intended use, proximal to the operator's location in a vehicle and use such determination to inhibit at least partially a plurality of wireless services.

In an alternate embodiment the velocity determination is done by using the component of the satellite vehicle velocity as projected onto a surface that is essentially three dimensional, (such as the earth or a similar mathematical object), planar such as a projection of the earth's surface (positive or negative dilatation), wherein an indication of the satellite vehicle motion is projected onto the surface.

In yet another alternate embodiment navigational information is determined by keeping accurate time, using this accurate time and using the information from one of: a plurality of satellite vehicles greater than one satellite vehicle.

### BRIEF DESCRIPTION OF THE DRAWINGS

The above brief description as well as other objects, features, and advantages of the present invention will be more fully appreciated by reference to the following detailed description of presently preferred but nonetheless illustrative embodiments in accordance with the present invention when taken in conjunction with the accompanying drawings, wherein:

FIG. 1 is a schematic block diagram of a differential from the known art.

FIG. 2 is a schematic block diagram showing a typical orientation of wheels for a four-wheeled vehicle from the known art.

FIG. 3 is a schematic block diagram of a device of a first embodiment in accordance with the principles of the present invention.

FIG. 3B is a perspective view of the device of FIG. 3, with all of the additional circuitry of FIG. 3 implemented as an adjunct attachment.

FIG. 3C is a schematic block diagram of the navigational part of the navigation and orientation entity, 412, of FIG. 3 from the known art.

FIG. 3D is a data flow diagram showing a thread of one method of very accurately deducing velocity, from the known art.

FIG. 3E is a data flow diagram showing a thread of one method of very accurately deducing velocity, from the known art.

FIG. 4 shows part of the navigation and orientation element of the device of FIG. 3, in this case three orthogonal mounted tuning forks, from the known art.

FIG. 4B shows a Rotational Vibrational Coriolis Gyro, a part of the navigation and orientation element of FIG. 3, alternate to that of FIG. 4.

FIG. 4C depicts an inertial measurement unit, an alternate/supplement to the navigation and orientation entity, 412, of FIG. 3.

FIG. 4D shows a portable wireless device with multiple antenna elements sensitive to incoming signals usable for radio navigation, part of the navigation and orientation entity, 412, of FIG. 3, an alternate to those of FIGS. 4, 4B, and 4C.

FIG. 4D shows a laser ring gyro, part of the navigation and orientation entity, 412, of FIG. 3, an alternate to those of FIGS. 4, 4B, and 4D.

FIG. 4F shows an inertial sensor, an alternate to that of FIG. 4C.

FIG. 5 shows an aspects of a vehicle on a linear trajectory leading to a curved trajectory and certain aspects of a vehicle on a curved trajectory, with certain intervals of the latitude and longitude overlaid.

FIG. 5B shows a trajectory of the portable wireless device of FIG. 3 when located on the right side of a vehicle.

FIG. 5C shows the trajectory of the portable wireless device of FIG. 5B, when located on the left side of a vehicle traversing a smaller arc.

FIG. 6 is a diagram showing the displacement profile of the device of FIG. 3 for the example of transiting a curve in the road, and associated parameters of speed (velocity in the local frame), acceleration, and jerk.

FIG. 6B is a diagram of an alternate displacement profile of the device of FIG. 3 as it transits an exemplary intersection.

FIG. 6C is a diagram indicating construction lines used to deduce the radius of curvature of trajectory of the device of FIG. 3 for an exemplary turn to the right.

FIG. 7B is a diagram showing an alternate motion of the invention in the rear of a vehicle transiting an intersection.

FIG. 7C is a diagram showing an alternate motion of the invention in the front of a vehicle transiting an intersection.

FIG. 7D is a diagram showing an alternate motion of the invention in the rear of a vehicle traversing an oblique curve in the trajectory.

FIG. 7E is a diagram showing an alternate motion of the invention in the front of a vehicle traversing an oblique curve in the trajectory.

FIG. 8 is a diagram showing an exemplary method of motion analysis of the invention in a vehicle following a turning trajectory with turns in alternating directions.

FIG. 9 shows the plan view of a lane change of the device of FIG. 3.

FIG. 9B depicts a diagram of a roadway wherein there is at least a single change of direction, of the device of FIG. 3.

FIG. 9C depicts a diagram of a roadway wherein there is known information about the distance between the stop line and certain locations within a lane of an essentially perpendicular roadway.

FIG. 10 is an informational flow chart showing operations performed by the devices of FIG. 3, and FIG. 11 (to be explained later).

FIG. 10B is an informational flow chart showing operations performed by the device of FIG. 3.

FIG. 10C is an informational flow chart showing operations performed by the device of FIG. 3.

FIG. 10D is an informational flow chart showing operations performed by the device of FIG. 3.

FIG. 11 shows an alternate method to that of the device of FIG. 3 for determining velocity, acceleration or jerk vis-à-vis satellite vehicles, using known information.

FIG. 11B shows an alternate method to that of the device of FIG. 3, and that of FIG. 11 for determining velocity, acceleration or jerk that corresponds to integrated Doppler frequency changes.

FIG. 12 is an alternate schematic block diagram, alternate to that of FIG. 3, showing battery-disabling configuration contained within the physical battery confines.

### HOW THESE ELEMENTS INTERACT

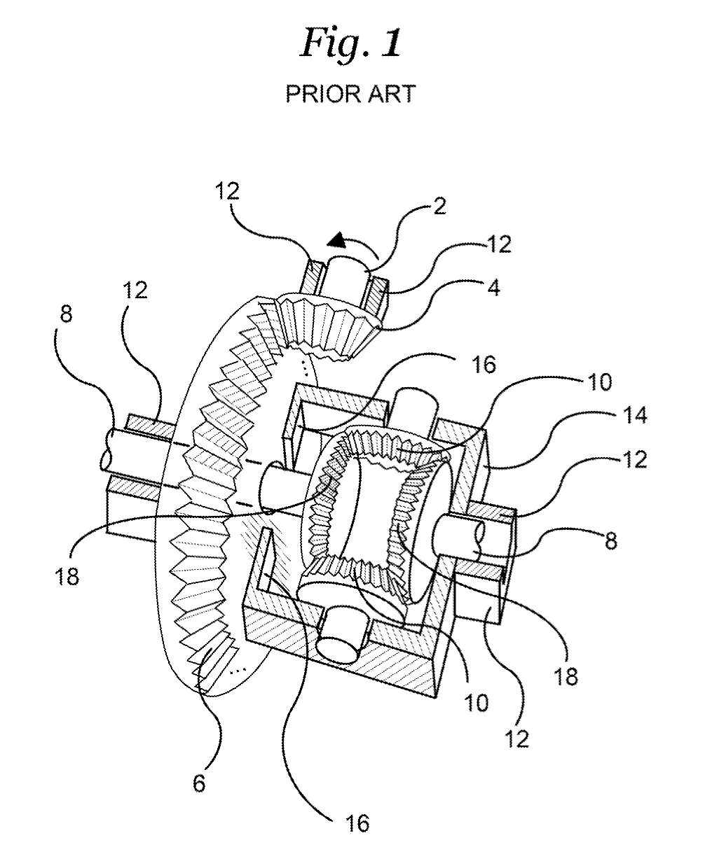

Referring to FIG. 1, Item 2 is the drive shaft end as it enters the differential from the torque source (torque source not shown for clarity).

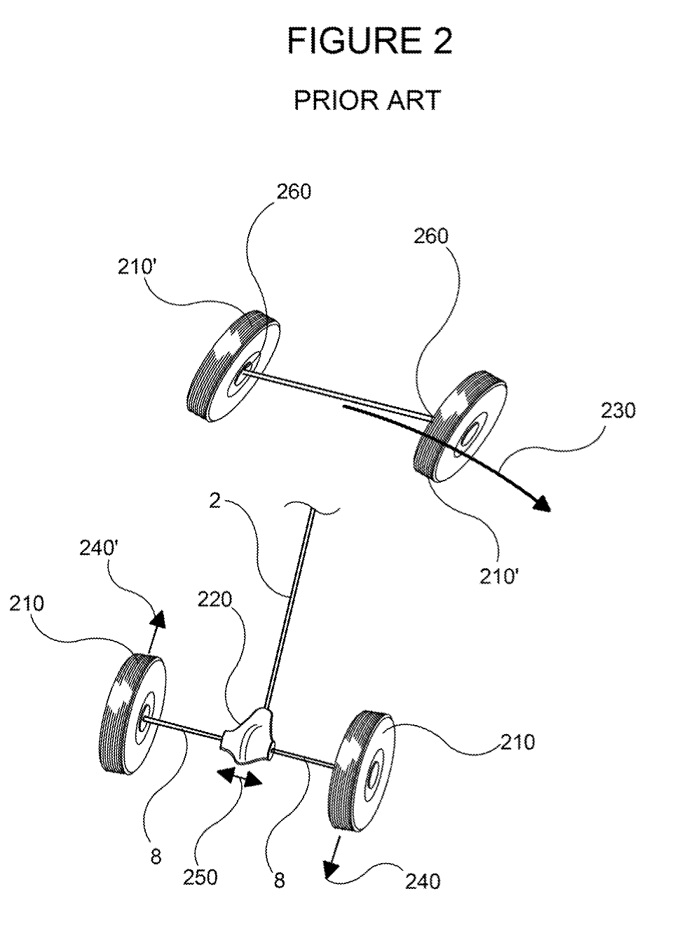

Bearing elements, (in cross-sectional view) 12, (Supported by overall differential outer case item 220, FIG. 2) support and permit engagement of the drive pinion gear, 4 (FIG. 1), and the crown gear, 6, (FIG. 1). Referring to FIG. 1, input shaft, 2, drives the drive pinion, 4, which in turn drives the crown gear, 6. Mounted on crown gear, 6, is differential and half shaft bevel gear support structure, (in cross-sectional view) 14, bolted to the face of, and supported by, the crown gear, 6.

Half shaft bearing, 12, supports half shafts, 8. Differential and half shaft bevel gear support structure, 14, is bolted to the face of, and supported by, the crown gear, 6, by bolts, inserted at location 16. The crown gear, in turn, is supported by bearings, 12. Half shaft bevel gear faces are shown as 18. Differential pinions, 10 permit the transfer of the rotational load of the crown gear, 6, now transmitted to differential and half shaft bevel gear support structure, into the combination of the half shafts, 8.

Half shafts (output shafts), 8, are used to drive the vehicle wheels, not shown for clarity. The differential permits relative rotational movement of the output shafts going to the drive wheels with respect to each other, while driving the pair or output half shafts, 8. FIG. 2 shows rear wheels, 210 and front wheels, 210′. Item 260 are the bearings upon which the front end is steered, (not visible) typically comprising king pin, ball joints etc. Half shafts, 8, are the half shafts as partially indicated in FIG. 1, are used to drive the, in this case rear, wheels, 210 FIG. 2. The differential of FIG. 1 is depicted here with cover, 220 FIG. 2. In this figure more of the drive shaft, 2, is shown.

During times when the vehicle is cornering, for example to the right, the front end of the vehicle, and hence the front wheels, 210′, FIG. 2, in the moving frame of reference centered on the vehicle center of rotation, to be explained here presently, rotate laterally about the center of rotation. The cornering event necessitates different speeds of rotation of the rear wheels with respect to each other. Because the crown gear is typically being driven, the support structure 14, of FIG. 1, is of necessity rotated. As the support structure is turned the pinions 10, rotate about the axis formed by the half shafts, 8, applying torque to the half shafts 8 collectively. As the vehicle corners the wheel on the inner side of the turn attempts to rotate about its half shaft at a slower rate. The differential permits this. Similarly the wheel on the outside of the turn is required to rotate about its half shaft at a faster rate.

The average rotation rate of the two rear wheels, 210, remains approximately the same during the turn. If we neglect the terrain/roadway that the vehicle traverses, we can consider the wheels in this moving frame of reference, moving at the average speed of the two rear wheels.

When taken in this moving frame of reference, at essentially constant velocity, with the differential essentially at the center of the frame, the motion during a turn appears as one rear wheel rotating forward very slowly, and one rotating backward very slowly at approximately the same rotational velocity, when the motion of each wheel is taken in comparison to this otherwise constant velocity. The movement with reference to the center of rotation, this would entail, in e.g. a right turn, is shown by 240 and 240′. Additional movement to note is that of the front end which rotates to the right, shown as item 230, about the center or rotation, in our moving reference frame example.

Because the rear wheels 210, of FIG. 2 are slightly different diameters, or different tire pressures, straight travel will result in one of the half shafts, 8, rotating at a slightly different rate to make up for this difference. This will result in slight relative rotational motion between the output shafts, 8, even during linear motion. The amount of this rotational rate difference is essentially negligible, but it governs the location at which the center of turning occurs, i.e., it will be close, but not exactly in the center of the rear shaft.

Because this effect is very small it has the effect of pushing the center of rotation slightly to one side. The effect is irrelevant to the present issue of linear speed comparisons (to be explained presently) to the average for travel along a straight stretch of road, although it means that the location of the center of rotation, (in plan), is not necessarily at the differential, although very close for either of these conditions of different tire pressures or different tire diameters. This small range within which the center of rotation is located in the moving frame centered on the average of the two rear wheels is indicated by item 250.

Either Posi-traction or limited slip differential, at least partially restrict the movement of one of the output shafts with respect to each other. This is typically for tight turns at very slow speed operation and consequently of limited concern to the present discussion, which concerns motion at slightly higher speeds.

Of note for later discussion, the turning circle of the front seat occupants is marginally larger than that of the rear seat occupants as the rear wheels keep aiming at the location of the front wheels. This effect is true of vehicles with steering by front wheels only.

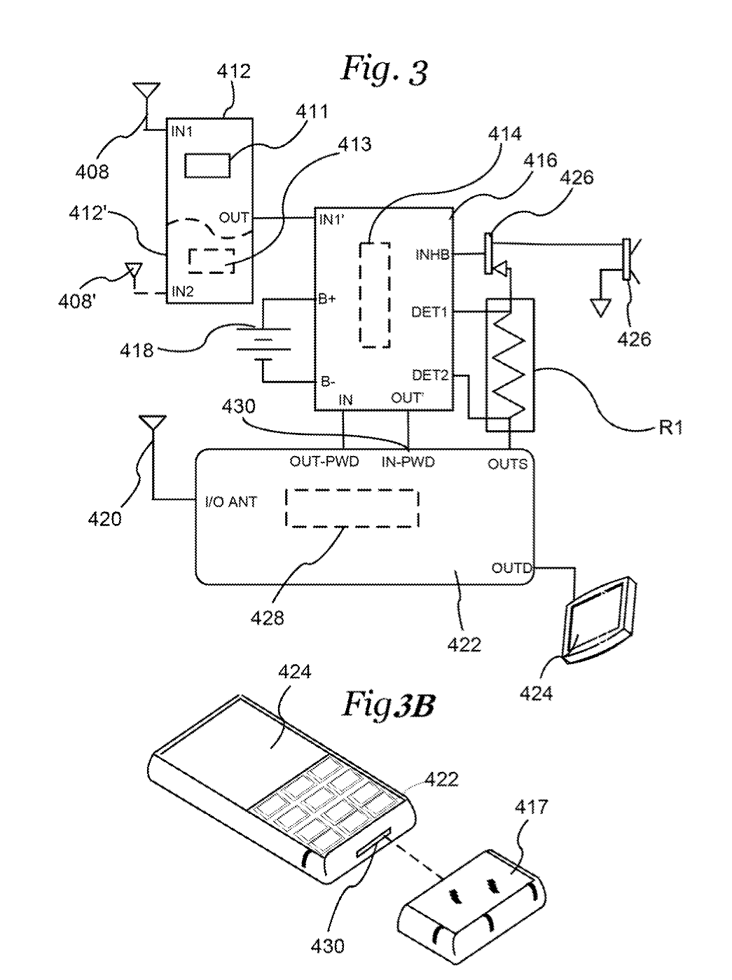

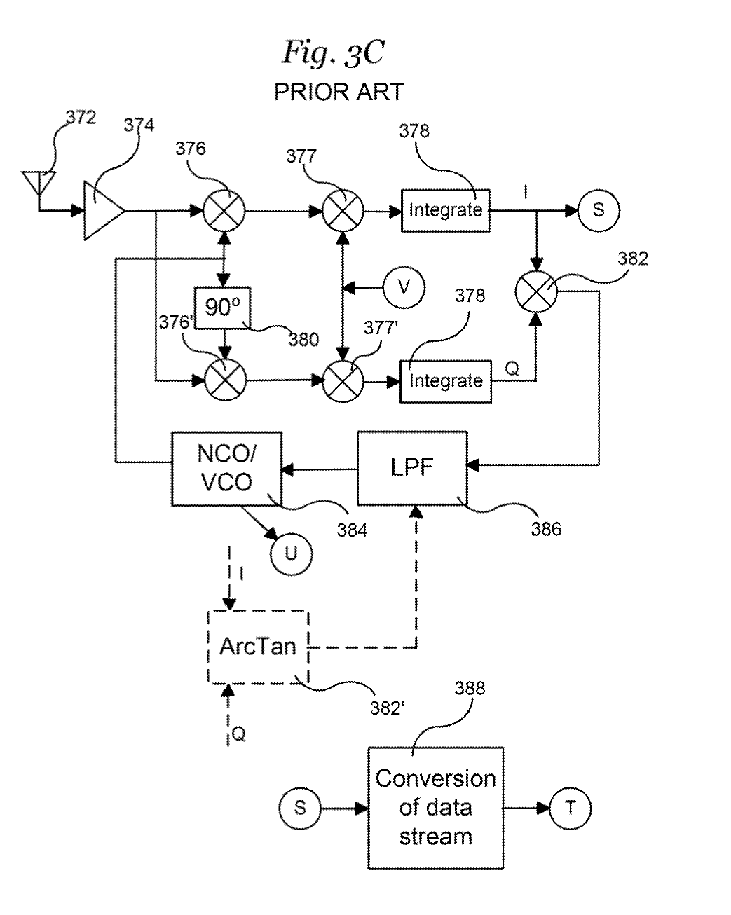

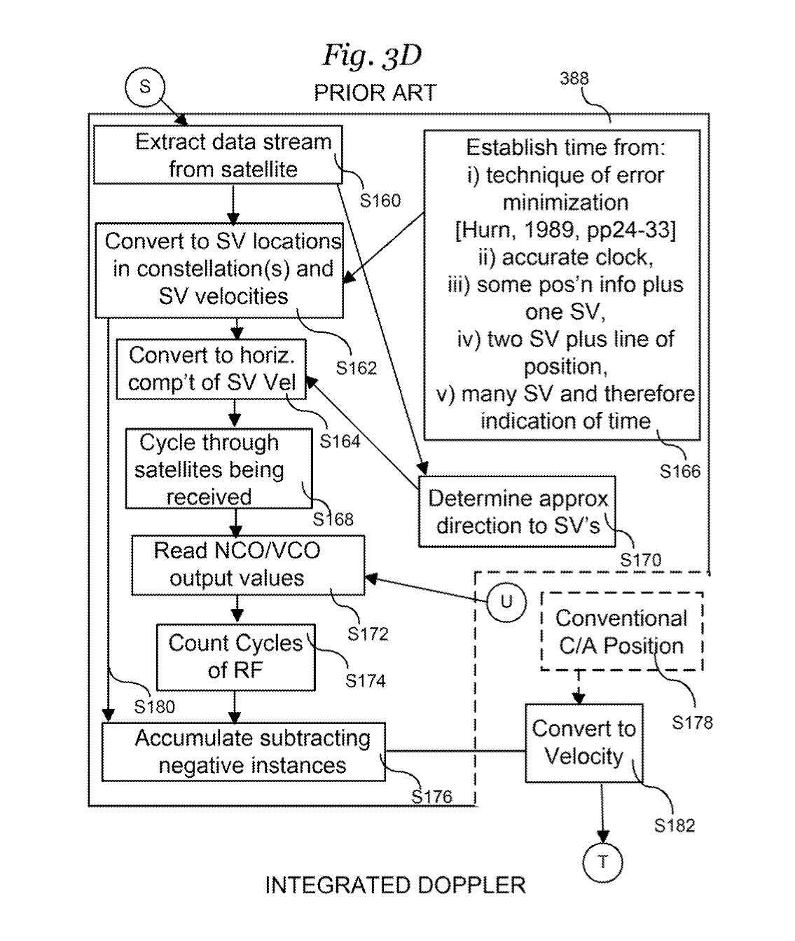

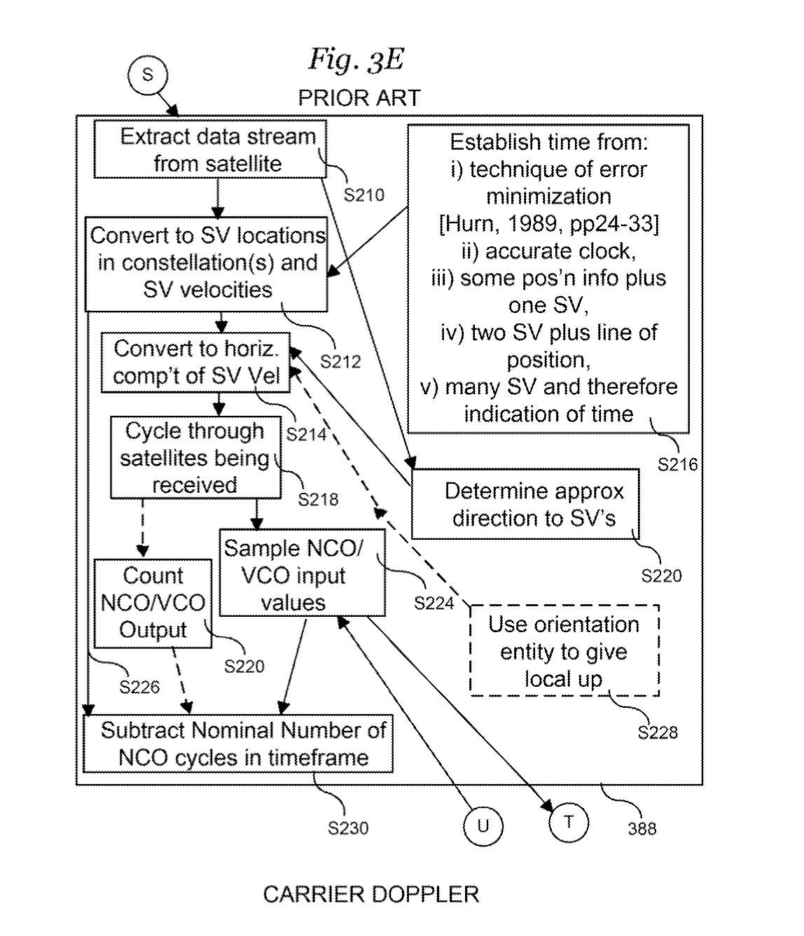

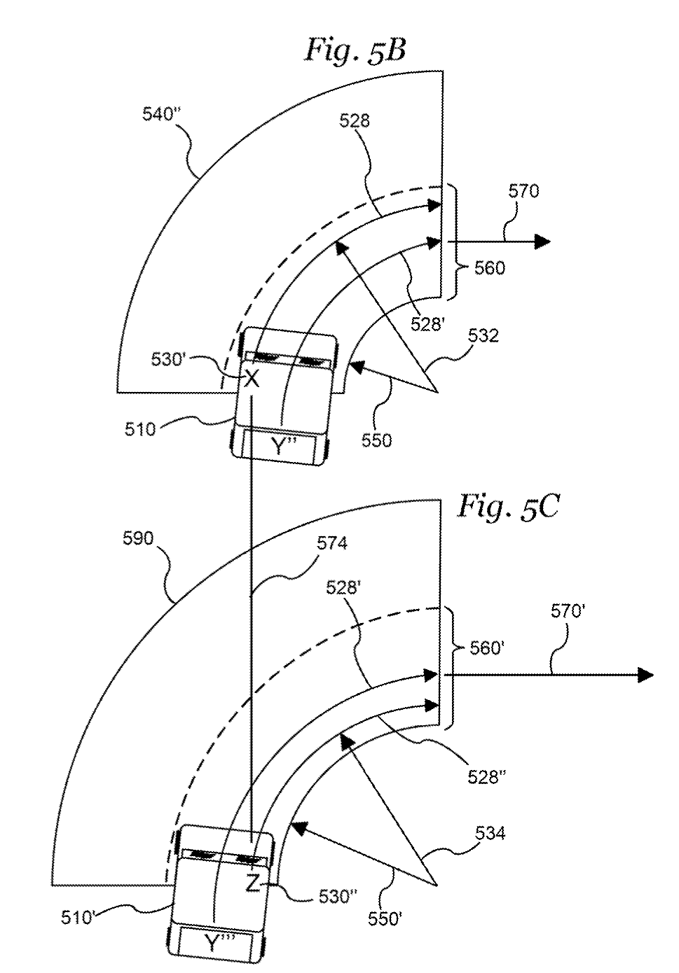

FIG. 3 depicts the schematic block diagram of processor, 416, with memory, 414. Processor 416, is supplied navigational and orientation information via input IN1′. Navigation and orientation entity, 412, receives incoming information from navigational antenna, 408, and optional second antenna 408′, supplied to input connectors IN1 and IN2 respectively. Although not shown for clarity, it is assumed that optionally multiple such antennae are present and input via inputs IN3, IN4 and so on. Navigational and orientation entity, 412, resolves at least one of: an indication of velocity, location, acceleration, jerk, speed, orientation with respect to navigation satellite and supplies this to processor, 416, with memory 414, powered by power supply 418, in this case shown as a battery. Oscillator, 411, permits accurate timing of many aspects to be discussed later. Memory, 413, is used to store data of a velocity, navigational or orientation nature for further use. All items in FIG. 3 except 420, 422, 424, 428, 430, are contained in item 417, of FIG. 5.

Processor, 416, keeps a running average, for which it accumulates instances of success and decrements for instances of failure (although not necessarily of the same weighting), in its memory, along with other constants, variables and program memory. At the point of decision, processor, 416, signals, via its output, OUT', to the remainder of the portable wireless device, 422, via it's input, IN-PWD, and via connector, 430. Remainder of the portable wireless device, 422, with memory, 428, is optionally in communication with an external network entity, via antenna, 420, at its input port, I/O ANT, exploits at least one of: software, hardware, network entity, wherein it at least one of inhibits, partially inhibits, qualified inhibits, signals, or permits continued use based on intended operational context, such as 911 use. Optionally processor, 416, receives network parameters, via portable device, 422, and antenna, 420. This information is indicative of a location (e.g. country) for vehicles of either left hand drive (i.e. N America, etc.) or right hand drive (i.e. Britain, and most former British territories, etc.). Portable wireless device, (proper) 422, informs the user of action via speaker output OUTS, as well as, informing the network, and in turn user(s) at the other end of the communication, via output I/O ANT, and the network (not shown), and to speaker 426, via OUTS, or display output OUTD, to display, 424, to inform user via output port OUTD, or others in communication, or attempting communication, via antenna 420, and network, etc.

An alternate arrangement to the above has the portable wireless device (proper), 422, outputting signal to its hands-free speaker/microphone (microphone not shown for clarity) combination, FIG. 3, 426, with current shunt R1, typically a small valued resistor, being sensed by analog inputs, DET1/DET2, 416, and if in use, prevents use thereof by switching off switching element 426, shown here as a field effect transistor. Signal detected by processor, 416, signals to the remainder of the circuitry that the user is attempting to use or using the hands-free element of the device. Similar signal concerning Bluetooth use is available internally, the use of which is determined and forwarded to the same circuitry as the signal detected by DET1 and DET2, and is treated in similar fashion.

FIG. 3B depicts the device of FIG. 3 wherein the portable wireless device, 422, has screen, 424, and external attachment connector, 430, connected to the present invention, 417, shown here in adjunct device version.

FIG. 3C depicts a schematic block diagram of a Costas Receiver suitable for a determination of pseudo-range information from one Satellite Vehicle (SV).

Signal is received at antenna element, 372, passed to Low Noise Amplifier, LNA, 374, optionally down converted to an IF frequency. LNA, 374, output is sent to mixers 376 and 376′. Down-conversion to baseband occurs in mixers 376, and 376′ which are supplied in-phase and quadrature components of Numerically Controlled Oscillator (NCO)/Voltage Controlled Oscillator (VCO), 384. The baseband In-phase and quadrature components of the received signal leave mixers 376 and 376′ and are subsequently passed to in-phase and quadrature mixers 377 and 377′, where in-phase and quadrature simulated Pseudo-Random Noise (PRN) code is used to modulate the incoming signals resulting in de-spreading of the signal. Low pass filtering and bit synchronization is performed at 378 before the In-phase and quadrature components are combined at phase detector 382. The combined I and Q paths are subsequently routed to low pass filter, 386, and then to NCO/VCO to be used for the carrier tracking function. In-phase signal, data stream S, is sent to processing block, 388, where overall receiver frame synchronization, Kepler equation solution, using a second order Newton-Raphson solution is employed, prior to use for conversion of the position relative to the SV, to that of local coordinates. Processing element, 382′, an alternate to that of 382 above, takes the arctangent of the in-phase and quadrature components of the signal and outputs this to the Low Pass Filter (LPF), as 382 does when used, the output of which is used to control NCO/VCO, 384.

To acquire the satellite signal initial attempts to correlate various Pseudo-Random Noise PRN codes representing the various SV's in the satellite constellation, are typically attempted in sequence, with open loop attempts at all possible Doppler shifts of the carrier. As intervals of different down conversion frequencies attempt to down convert the incoming signal, signal strength of the correlation elements, 378, is sampled while the control loop adjusts the timing of the PRN code slightly to exact match that of the incoming signal. As the signal is mixed down to complex I &Q, baseband by frequency mixers 376 and 376′. After integration, (low pass filtering) the complex baseband signal error signal remains and is used to adjust the NCONCO to match the incoming carrier frequency. The error signal will cause the NCONCO to lock on either zero or 180 degrees phase. SV code is also adjusted back and forth in phase until the match between incoming signal and the replica code are maximized at the output of the integration function. Once the first SV is acquired, primitive data concerning the other SV's is obtained. As more of the SV's are acquired the loop parameters are typically adjusted, such as narrowing the bandwidth. This knowledge of where the other SV's are and which SV codes will most likely render successful correlations (optionally using known position), the control loop attempts to lock. As is typical, the lock attempts to lock in frequency first and then subsequently in phase. To track the signal further refinements of the frequency and phase occur. [adapted from Grewal, p 85]

Once locked, control signal going to NCO, 384, signals the amount of Doppler shift representative of the change in distance between the receiver and transmitter antenna phase centers, as the carrier loop tracks the signal. Processor, 416, of FIG. 3 continually integrates this information to make a determination of velocity with respect to the SV being received. It is understood that in some embodiments the PRN generator is triplicated and has a copy of the PRN replica that is early, another that is punctual, and still another that is late. Comparisons of the correlation values resulting from these early and late correlators permit adjustment of the phase of the code replica being used, as well as a refined estimate of the code chip phase that represents the distance that is close to the SV/user distance. In some embodiments this is further refined by doing comparisons with the RF phase. In some embodiments this is further refined by a comparison between RF phase and the relative phase transitions corresponding to the chips in the PRN. In still yet other embodiments the RF phase is used to directly deduce the velocity of the user, and the change in velocity of the user with respect to that particular SV.

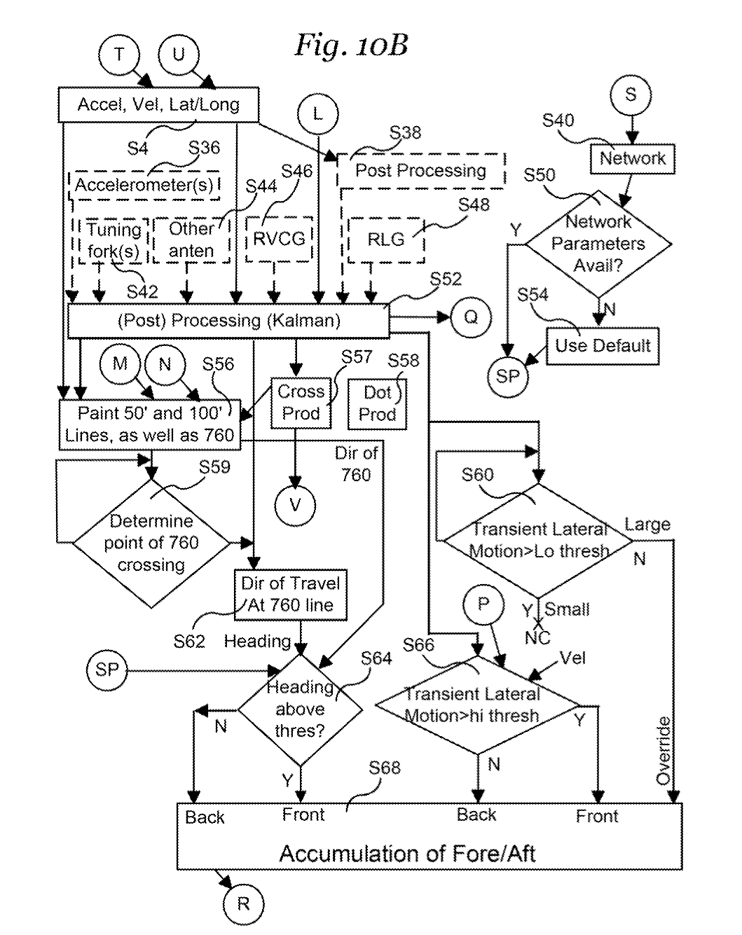

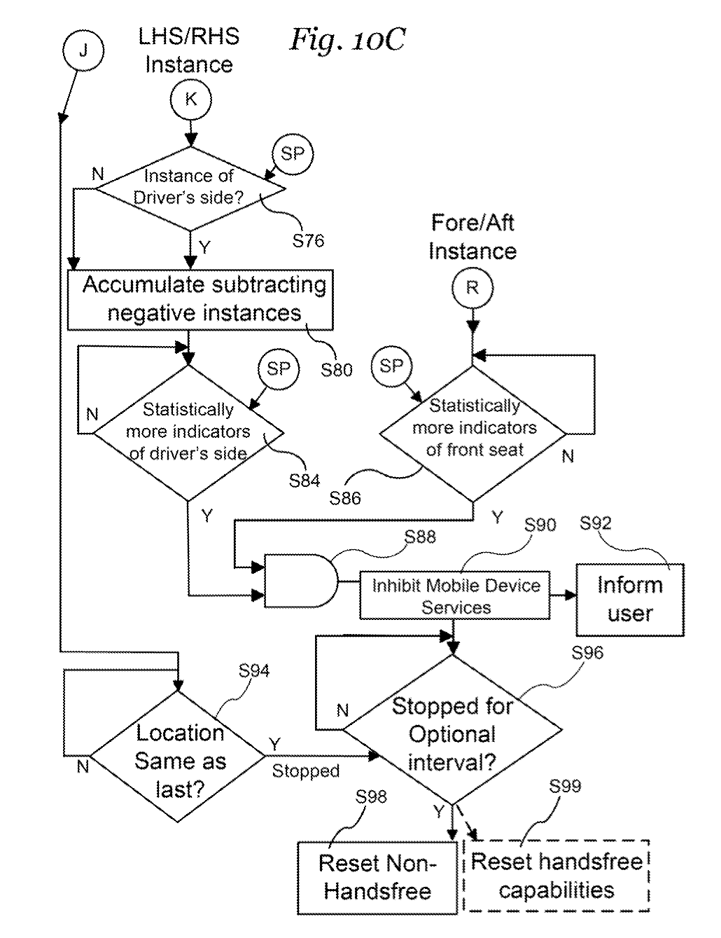

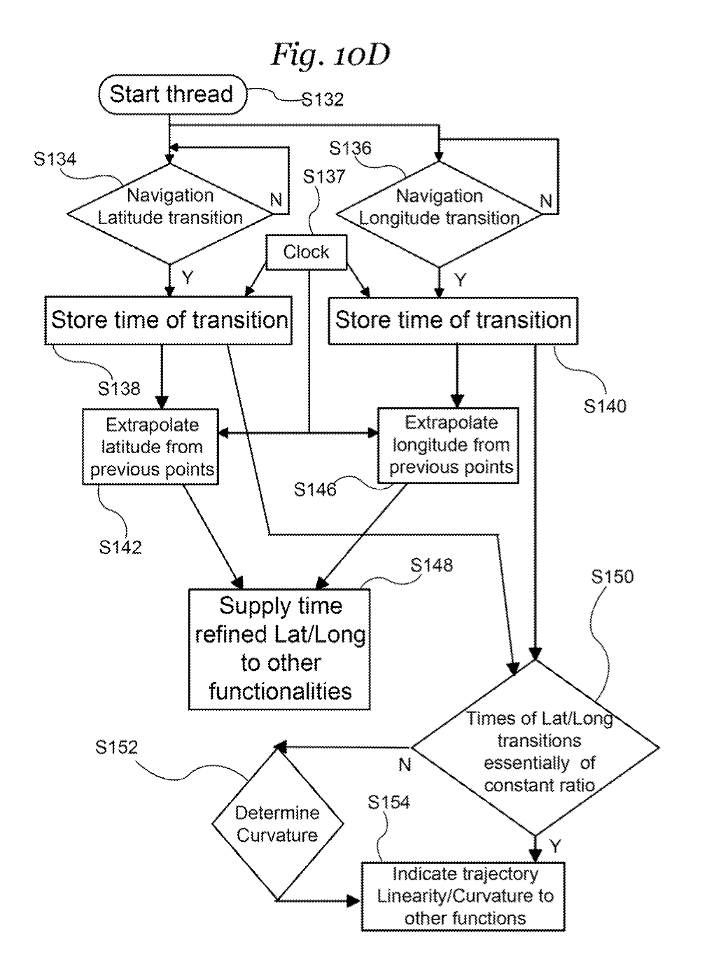

It is understood that signal from the other SV's require circuitry similar to that of FIG. 3C with at least some parts, duplicated, triplicate, quadruplicate, quintuplicate, etc, or otherwise multiply parallel to that of FIG. 3C, for reception of signal from other SV's. These are referred to as receiver fingers. It is understood that once the refined position is located with respect to the SV constellation that it is converted via signal conversion element, 388, and output as T. Both signals T, and U are provided to step S4, FIG. 10, (to be introduced later), and steps S38, S52, and S56 of FIG. 10B (to be introduced later). Signal U, represents an indication of the carrier phase.

FIG. 3D. shows the integrated Doppler method of refining velocity, acceleration, or optionally position.

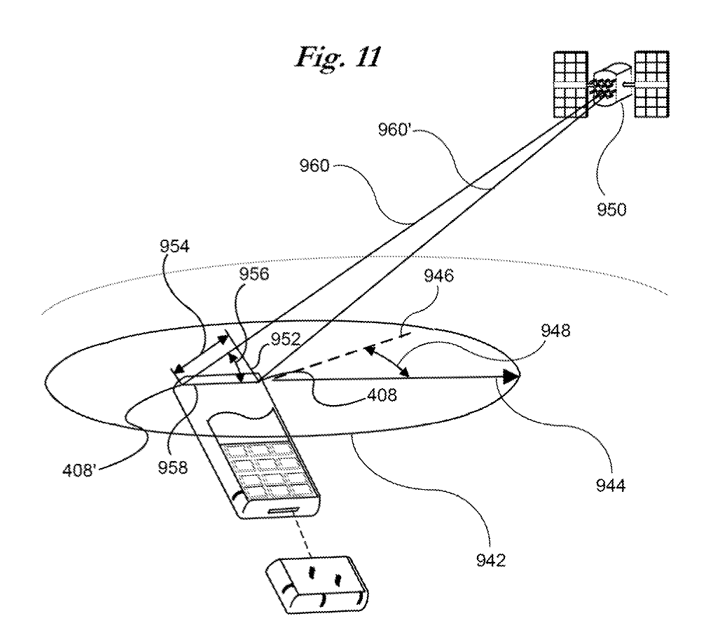

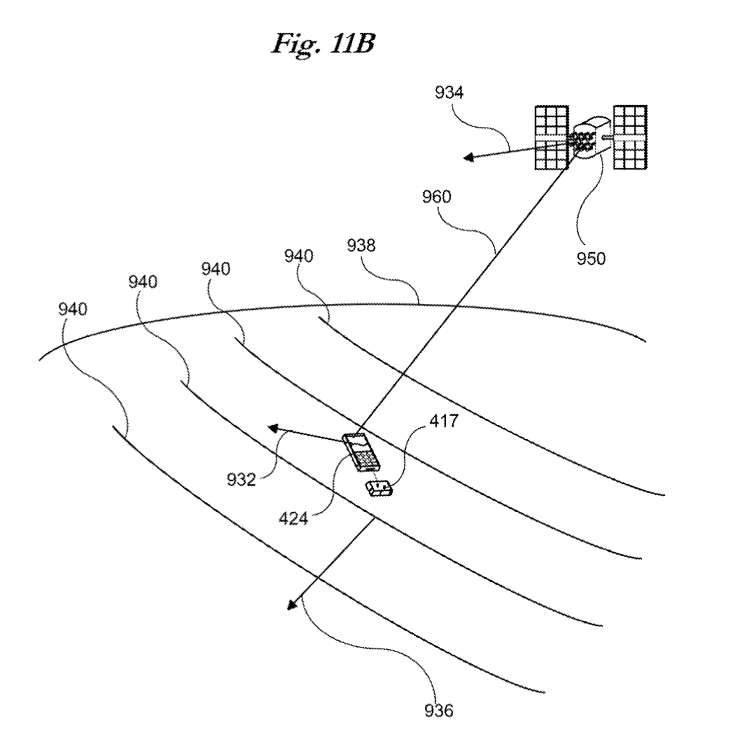

At step S160 data from the In-phase branch of the Costas Loop of FIG. 3, S, is extracted from the data stream, via any of the methods known in the art. This data stream is converted to the satellite locations, times and velocities in the constellations. Step S170 using a technique to be explained later in the context of FIGS. 11 and 11B, determines the approx direction to the SV's. Step S164 uses the data stream and the approximate directions to the SV's to convert the incoming velocities of the differences between the user's and the SV's velocities. By integrating the values, of the data coming from the DCO/VCO, U, which is coming from the output this time, step S164 converts this to the horizontal component of the SV's velocity in the user's frame of reference (not necessarily level, or not necessarily with respect to the user's local references). Step S168 cycles this activity through all of the SV's within reception area and supplies it to the next step S172, where the satellite's Doppler is effectively negated as it is only the short term difference in the difference in the SV and user's velocities that will show up in the integration value. (SV Doppler changes over a much longer time frame). The user's velocity is the only one that shows up in a running average. This method is adapted from [Grewal, 2007, and others]. By keeping a running average, and per SV adding the count of positive or subtracting the count of negative NCO/VCO output cycles. The changes thus determined are supplied by step S176 to step S182, that optionally in conjunction with a very rough estimate of position, e.g., from C/A pseudo ranging only, step S182 converts the integrated NCO/VCO count into a very accurate estimate of user velocity. It is noted that other methods of supplying the necessary orientation reference to step S182 are available, such as from navigation and orientation entity, 412, of FIG. 3. (This detail is not shown for clarity)

FIG. 3E shows the carrier Doppler method of refining velocity, acceleration, or optionally position.

At step S210, the data is extracted from the In-phase component of the complex error signal. The extracted data stream is stored and converted by processor, 416, of FIG. 3 to SV locations, and velocities in any convenient coordinate system, at step S212. Step S214 uses this information stream, as well as, an indication of orientation from either step S228, data from the navigation and orientation entity, 412, of FIG. 3, or the cross product of delta latitude/delta longitude, (where delta means the difference in two consecutive values). Using this indication of horizontal the velocities from each of the SV's is taken and converted via the dot product of the velocity and the local vertical (=cross product of delta latitude and delta longitude), or as supplied by step S228. This is evaluated for each of the different satellite vehicles at step S218. At this point the information leaving the NCO/VCO, U, is a frequency estimate which is sampled from the NCONCO input at a given time interval. As the satellite to user Doppler frequency is that expressed along a line between the two. The Doppler frequency, f_{d} is given: λf_{d}=V·U−V₁·U₁, where U is the unit vector from RX to SV, V the user velocity, Vᵢ the satellite velocity and λ the GPS wavelength of 19.03 cm. This can be written for each satellite vehicle, i.e.,

λf_{d}=V·U₁−V₁·U₁ plus RX clock error

λf_{d}=V·U₂−V₂·U₂ plus RX clock error

λf_{d}=V·U₃−V₃·U₃ plus RX clock error

λf_{d}=V·U₄−V₄·U₄ plus RX clock error and so on.

The receiver clock error can be removed by the method described by

[Hum, 1990, page 24 to 33]

Adapted from [Grewal, 2007, p 93] incorporated here by reference from which the vehicle Doppler contribution is attributed. A convenient unit vector is taken from the user to satellite vector from for example a user fix, once established in the tracking mode. This value of velocity, which is very accurate, is used in calculations later in this disclosure. It is to be noted that, although possible, there is no need to calculate a position fix to attain this velocity information. The processor merely requires all of the information in the same frame of reference. It is understood that movement per either FIG. 3D, or FIG. 3E are known as Real Time Kinetic (RTK) arrangements. It is further understood that in some embodiments a network RTK arrangement is used.

It is permitted to have any method or device suitable for refined resolution of position supplying the motion information including, GNSS, GPS, GLONASS, BAIDOU, GAGAN, EGNOS, GALILEO, the cell network, any other radio-navigation system, used wholly, or in part, without deviating from the present disclosure. It is permitted to have any technique, or combination of techniques, of velocity, acceleration, jerk, position, or displacement known to a person of ordinary skill in the art, without deviating from the present disclosure.

It is understood that a further method of refined location difference, that of differential GPS, or differential GNSS is available for use as is known to persons of ordinary skill in the art. It is further understood that wide area, and local area based augmentation systems are able to supply further refined position information.

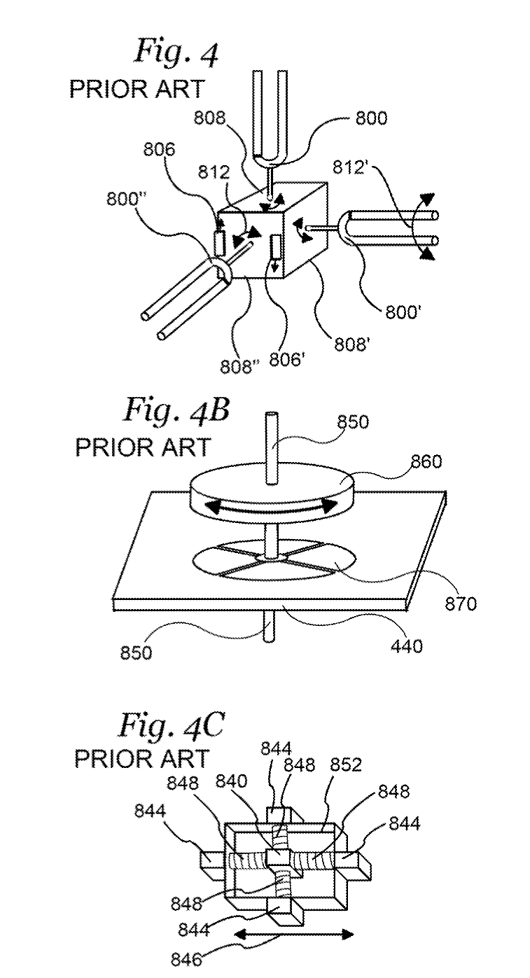

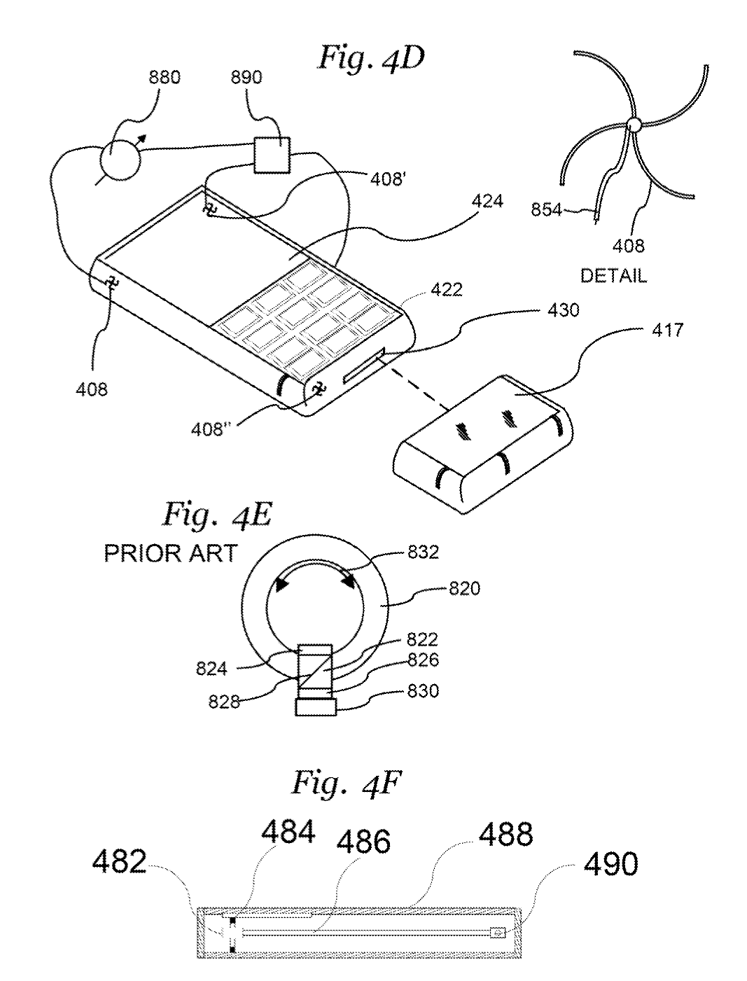

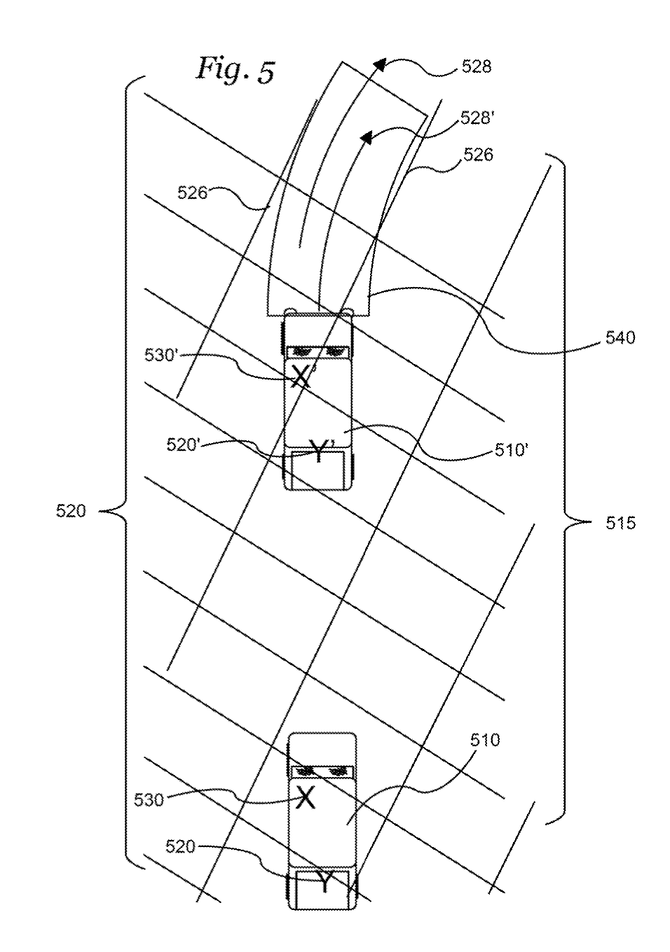

FIG. 4 depicts tuning forks, 800, 800′ and 800″. These elements are constructed of micro-machine dimensions and are installed on a printed circuit board, chip, or chip carrier.

Tuning fork, 800″, is located on circuit board, 808″, showing rotational motion 812, and installed inertial sensing elements, 806, and 806′ to resolve direction of rotation, of 800″. Rotation of the tuning fork about its major axis causes pressure on the tines to splay due to centrifugal force. This has the effect of changing the pitch of the tuning fork. Detection of the frequency of ringing offers an estimation of rate of rotation but not direction. For example consider motion about longitudinal axis of tuning fork 800″ for which this dilemma is resolved by the addition of accelerometer elements 806 and 806′, located at the base, to offer an indication of the direction of rotation, when compared to each other and the timing of the tuning fork change in pitch. Interface circuitry, not shown, samples the frequency of the tuning fork by acoustic coupler and fast Fourier transform (FFT). Indications of change in pitch determined by FFT trigger a sampling of the accelerometer pair to detect the direction of rotation experienced by the respective tuning fork.

The tuning fork assemblies, on boards 808, 808′, and 808″, are oriented at right angles, with appropriate processing, (not shown for clarity), to resolve angular movement, and acceleration. Signal output from navigation and orientation entity, 412, of FIG. 3, via output OUT to processor, 416. Boards 808, 808′ and 808″ are suitably equipped with accelerometers for sensing the direction of rotation when taken in conjunction with each other, e.g., 806 and 806′. It is noted that signal from accelerometers mounted in directions along the board edges are usable by both adjacent tuning fork assemblies. Signal supplied from this assembly, undergoes processing by processing element, FIG. 3, 416, prior to use. This processing is of a nature that is well understood by persons of ordinary skill in the art.

It is noted that changes in orientation can be completely determined by two such assemblies. In this assembly this is packaged monolithically as an IP core used as part of an integrated circuit implementing at least other parts of the overall circuitry.

FIG. 4B shows a heading determination element, an alternate to the rotational elements of FIG. 4.

Rotational Vibrational, Coriolis Gyro (RVCG), has rotating disk, 860, remaining at rest, with the remainder of the portable wireless device rotating about it during motion. The RVCG, permits the rotation of the disk, 860 about the axis, 850. Circuitry, not shown, causes the disk to rotate by electrostatic torque by charging the capacitive pads, 870, as well as a similar set of pads located on, and isolated from, the underside of the disk, or electro-magnetically by similar means. Rotation is sensed by measuring changes in capacitance present on pads, 870, at right angles, in the direction of rotation, due to precession from torque about any axis in the plane of the disk.

Capacitance is determined by using the capacitance as part of a tank circuit together with an inductance, sensing the resonant frequency, by exposing the capacitance, in series with a non-negative reactance, such as an, inductor, using it in conjunction with a resistor, or the capacitor's own internal resistance, or inductance to an oscillating voltage, sensing the phase of the current relative to the voltage, and determining the capacitance, and outputting the value to navigational and orientation entity, 412, of FIG. 3, alternately supplying orientation information to processor element, 416, of FIG. 3.

FIG. 4C shows a conventional Inertial Measurement Unit, (IMU), an element alternate to the navigational element of 412, of FIG. 3.

Housing, 852 constrains reference mass, 840, by six springs, 848 (top and bottom springs not shown). The springs serve to permit slight motion of the reference mass with respect to the housing. Four electro-mechanical detectors, 844, sense the motion and output electrical signal to the navigation and orientation entity. An increased tension detected by the detector outputs a signal that is proportional to the displacement of the reference mass, 840, which is proportional to the force upon it accelerating it. By integrating the signal from these sensors, 844, the navigation and orientation entity determines the velocity at which the housing is traveling. Alternate forms have the reference mass electro-magnetically pushed back into place and the amount of electro-motive force is detected electronically and sent to the navigation and orientation entity, 412, of FIG. 3, thereby avoiding additional considerations to linearize displacement of the reference mass, 840, motion relative to the housing, 852.

Alternate forms of this device exist.

FIG. 4D, shows an alternate arrangement for determination of orientation.

FIG. 4D includes a plurality of antennae, with connection 854, and a phase shifter, 880, and phase comparator function, 890, and is used for orientation alternate to that of FIGS. 4, and 4B. It is noted that an alternate means of orientation determination of a single antenna aperture, using the techniques of Kenan Ezal, et al., which is optionally incorporated as part the disclosure.

An alternate arrangement has signals from each of the different antennas, 408, 408′ and 408″. Each of the signals is processed in separate receive channels. Relative incoming RF phase is compared, an indication of which is sent to processor, 416 of FIG. 3.

Processor, 416, of FIG. 3, initially ignores the phase corresponding to that from antenna element 408, 408′, (and 408″, as applicable), until the phases from two such antenna elements match from random movement due to the user changing the portable wireless device orientation. Once the phases line up, Processor, 416, tracks the changes in phase beyond this point in time, and allocates an orientation change based on this phase change due to the difference in path length from the transmitter to the different antenna elements, 408, 408′ (and 408″ where applicable).

FIG. 4E, a laser ring gyro, shows an alternate arrangement for determination of heading, alternate to that of Figures, 4, 4B, and the salient features of FIG. 4D.

Laser ring gyro, has laser, 824, sensor 826, optical light path 820, interferometer 828, and electronic conversion module 830. Laser, 824, emits optical signal, impingent upon interference surface 828, gets launched in one direction along optical path 820. Entity, 826, also contains a laser. The laser in entity, 826, launches an optical signal in optical path, 820, towards the optical interference surface 828, whereupon it gets launched in the opposite direction to the optical signal aforementioned. The speed of light is a constant. When the Laser Ring Gyro is at rest the light departing in opposite directions has essentially the same path to travel in each direction. The signal arrives at the interference surface, 828, of the interferometer, 822. For cases of e.g., rotational movement, 832, space, particularly the distance in one direction, as opposed to the distance in the other direction around the ring changes, constricts, or expands due to this motion. This makes the path that light traveling in one direction has to follow to be longer than the path that the light traveling in the opposite direction has to travel making the two signals arrive at different times. The interference surface, 828, mixes signal from each of the optical signals, and has interference patterns that are indicative of the relative phase of the resulting light signal from the mixing operation, the signal interference pattern on the interference surface changes. This change is detected by imaging entity, 826, and has patterns thus generated processed and output to navigation and orientation entity, 412, (FIG. 3), by conversion entity, 830, FIG. 4D. Signal output from conversion entity is indicative of motion about the axis such as shown by 832. By the addition of two or three such Laser Ring Gyros at right angles to each other, the overall motion of the portable wireless device can be deduced. Alternate optical pathways for this device exist, including fiber optic wound on a spool, and triangle light pipes with mirrors at the apexes.

FIG. 4F, an alternate to the inertial sensor of FIG. 4C, shows an inertial switch that is comprised of reference mass 482, supported by semi-flexible element, 486, supported in housing, 488, by rigid mount, 490, which comes in contact with ring shaped conducting contact, 484, sensed by processor 416 of FIG. 3.

In one embodiment semi-flexible element, 486, permits contact with the ring shaped conducting contact, 484, at accelerations barely less than those in normal vehicle acceleration. Upon detecting a short between reference mass, 482, and contact ring, 484, the processor begins sensing inputs from the navigation and orientation entity, 412. Once powered the device functions as described elsewhere in this disclosure. It is understood that there will be a range of values over which this device might trigger. This range is to fit into a wide range of accelerations many of which will trigger this element. The unit may not trigger the evaluation of operator station proximity at exactly the same conditions each time but the orientation requirements of such a device on a portable wireless device or cell phone battery are much less stringent as a result.

FIG. 5 shows a vehicle, 510 with center of rotation, Y, shown as 520, prior to a straight segment of route. Portable wireless device, X, shown as 530 is located on the driver's side of the vehicle. Lines of latitude and Longitude, 526, are shown as 520, and 515, although not necessarily respectively. After the vehicle has transited the straight segment, the vehicle is in a location just prior to a curved section of roadway, 540. Portable wireless device X′ is about to transit curved segment 528, while vehicle center of rotation is about to transit curved segment 528′. Distance along the portable wireless device arc is longer than the distance along the vehicle center or rotation (in azimuth) arc.

Rate of vehicle movement squared can be determined by adding the sum of the squares of: rate of longitude change, and rate of longitude change.

FIG. 5B, has vehicle, 510 shown on lane, 560, segment of inner radius, 550 and outer curvature 540″.

Left side portable wireless device, X, located at 530′ follows trajectory 528, with radius 532. Vehicle center of rotation (in azimuth), Y″, follows trajectory 528′. Upon exiting the turn vehicle, 510, maintains essentially the same average velocity as it has along the arc, shown as 570.

FIG. 5C, has vehicle, 510′ shown on lane, 560′, segment of inner radius, 550′ and outer curvature 590.

Right side portable wireless device, Z, located at 530″ follows trajectory 528″, with radius 534. As an example radius 534 has been coincidentally chosen to be the same magnitude as FIG. 5B radius, 532, shown with shared construction line, 574. Vehicle center of rotation (in azimuth), Y′″, follows trajectory 528′. Upon exiting the turn vehicle, 510′, maintains essentially the same velocity as it has along the arc, shown as 570′.

FIG. 5B, has vehicle 510 shown on arc of radius 528′.

FIG. 5B, has vehicle 510, located such that portable wireless device, X, travels arc 528″

FIG. 5B, represents the instance wherein the user is on the vehicle right side at location Z. Vehicle differential, permits forward motion on the outside of the turn, and rearward motion on the inside of the turn, in the moving frame, during the turn, the vehicle's center of turn, located at Y remains in motion with essentially the same forward speed, although now, because the vehicle is turning, center of turning, Y, will be along an arced trajectory, 528′.

In similar fashion, (although not shown for clarity of the earlier discussion) once the vehicle has stopped turning the linear velocity of center of turning, Y, will remain essentially at the same linear speed, only now because the vehicle has stopped turning, the speed will be expressed along an essentially linear trajectory, 570 in our example. In FIG. 5B, the portable wireless device, Z, when turning, traces an arc, 528″ that is smaller than that of center of turning Y. Absent significant speed changes, prior to the turn (omitted for clarity), and after the portable wireless device speed will be faster than during the turn.

Referring now to FIGS. 5B and 5C;

FIG. 5C shows the portable wireless device user is on the vehicle left side at location X. The comparison with FIG. 5B, is deliberate. Shared construction line 574 indicates that location Z in FIG. 5B traverses an arc of approximately the same radius as that in FIG. 5C.

As before, absent any significant speed change, location Y, essentially at the vehicle speed prior to, and subsequent to, the turn. In FIG. 5C, center of turn, Y, traces a smaller arc, and consequently vehicle speed before and after the turn is a smaller value, indicated by 570′ (in comparison to 570 FIG. 5B).

Vehicle, 510, before and after are at speeds similar to that of the center of turning, Y. In the example of FIG. 5C, because the center of turning is now inside the location of the portable wireless device user, the speed of the center of turning is detectably less than that of the portable wireless device user, by measuring the portable wireless device trajectory, speed in this case, prior to, or after the turn. The example of after the turn is shown as essentially linear trajectory, 570′.

The value of the speed of the trajectory 570′ offers a value representative of the center of vehicle turning, Y, even if only expressed as such at the moment of entering, or exiting the turn.

More importantly the change in the speed of the portable wireless device, in either case FIG. 5B, of FIG. 5C, or their equivalent cases during turns to the left, as the portable wireless device speeds up, or slows down, is most closely associated with the beginning of a right turn, left turn, or the end of a right turn, or left turn. Rate gyro, information to be later discussed will offer an indication of whether the turn is to the right or the left, and whether the turn is beginning or ending. Taken in conjunction with the up to 3-dimensional rate gyro information, by taking comparisons with the portable wireless device accelerations, indications of whether the portable wireless device is on the left or right side of the vehicle are deduced. When taken in conjunction with an indication that the portable wireless device network is in jurisdictions taken to use right hand drive vehicles, or left hand drive vehicles, instances of operator use, or intended use can be deduced, accumulated, or otherwise used.

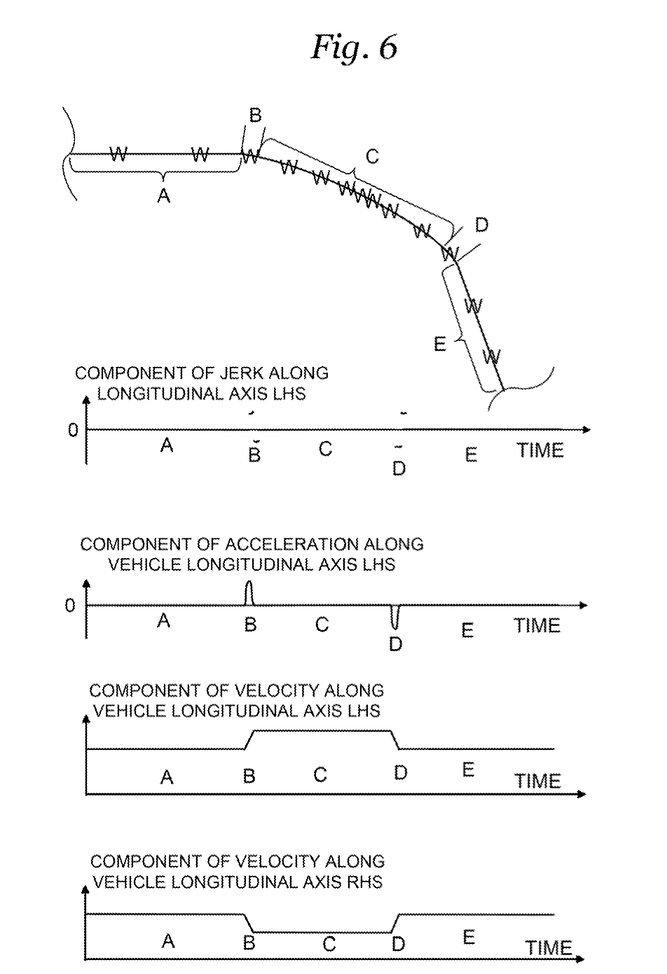

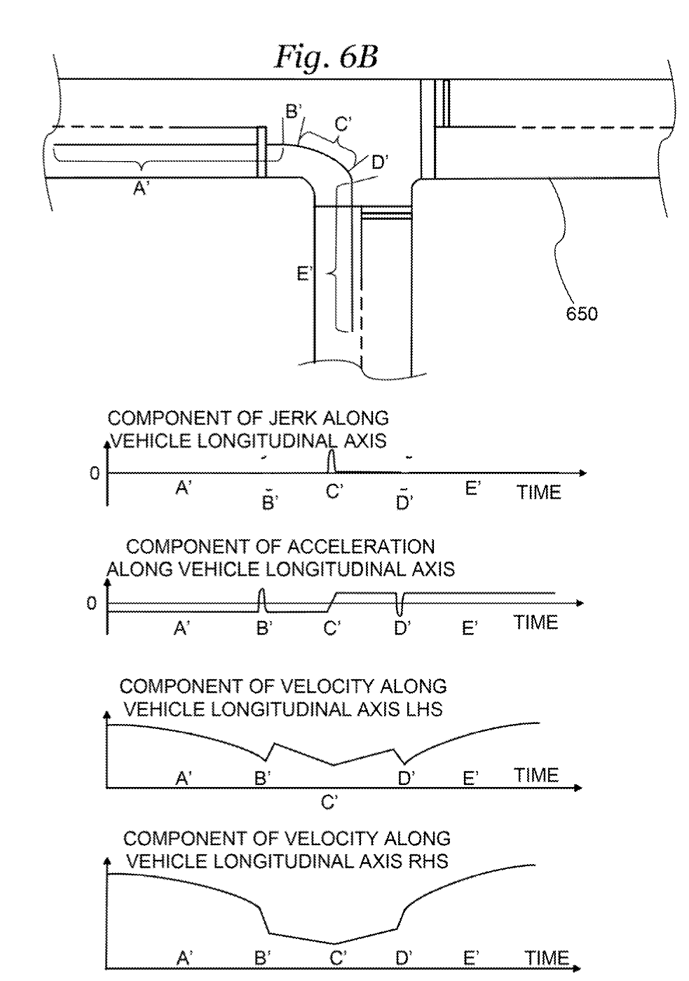

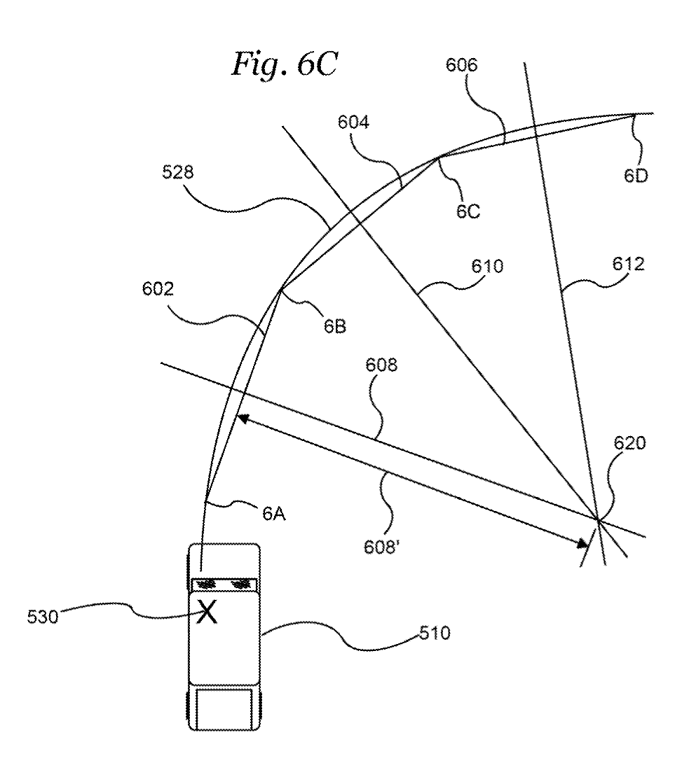

FIG. 6 indicates typical trajectory during a turn.

The vehicle position is shown as along this trajectory as points along segments A, B, C, D, and E. Times taken during the turn are shown as W's.

Velocity profiles are shown below. In this example, with the portable device in the left side of the vehicle, the left side velocity is faster than the right side velocity during the turning aspect of the vehicle trajectory. The left side in such a right hand turn has a further distance to travel in like time resulting in a faster speed, i.e., velocity with respect to the vehicle's longitudinal axis.

The acceleration profile, shown for the left side (LHS) case only, has sharp indications during changes in the steering inputs, as does the jerk profile, again shown for the left side (LHS) case only. In this context acceleration and jerk are taken to be in the direction of travel.

This effect is also present for transitions other than those on cruise control, although they may be shorter lived and have slightly less well-defined profiles.

FIG. 6B shows a vehicle for a typical turn at an intersection.

As before, the vehicle transitions through FIG. 6B locations A, B, C, D, and E. Velocity profiles of the vehicle show essentially constant deceleration, followed by essentially constant acceleration which begins at the point during the turn where the operator perceives that the vehicle is no longer a slip risk and that acceleration can resume, as the vehicle heading is acceptably close the desired ultimate heading.

Similar to the transit of FIG. 6, the right side (RHS) and left side (LHS) profiles of FIG. 6B indicate that velocity profiles tracked to a suitably fine degree offer an indication of right side or left side of the vehicle by determining the polarity of transitions at any of the combinations of: B′ (entering turn), at D′ (leaving turn), or at B′ and D′ (both entering and leaving turn). The example profiles for acceleration and jerk are shown for the right side case.

Processor, 416, of FIG. 3, filters motion for forward velocity, and in the absence of uni-polar jerk declares it an instance and either increments or decrements the running average filter, prior to use of this parameter.

Filtering for motion in the longitudinal direction, i.e. sufficiently similar to the direction of travel made good over a small recent interval, and looking for the initial change in heading and then the bi-directional longitudinal jerk, processor, 416, of FIG. 3, determines whether the vehicular motion is entering or exiting the turn. Turns with more than simple motion i.e. not compound turns are optionally filtered out and don't contribute to the running average. It is this process step that filters the resumption of longitudinal acceleration (from driver inputs), at C′, from an acceleration such as B′ or D′. The acceleration at location C′, is fundamentally different in that all of the acceleration at C′ is as a result of vehicle braking followed by acceleration (stepping on the gas pedal). Prior to the turn a vehicle is decelerated while still on a linear trajectory. The linear trajectory is identified as such from a constancy of heading. As the linear deceleration leading to the turn, A, occurs, the estimate of the deceleration component from this braking action is first estimated from navigation and orientation entity, 412 of FIG. 3, and then extrapolated. The extrapolation is subtracted from the vehicle deceleration prior to the estimate of the acceleration caused by the onset of turn. It is the component of the extrapolation of linear deceleration taken in the direction of vehicle travel (form the navigation and orientation entity, 412, of FIG. 3) that is used. In another embodiment the acceleration along segment, E, after the turn is treated in similar fashion in post processing performed by processor, 416, of FIG. 3.

FIG. 6C shows vehicle 510 traveling along trajectory 528.

Portable wireless device, X, shown in FIG. 6C, in a vehicle, 510, making a turn along trajectory, 528, construction lines, 602, 604, 606, . . . are computed by processor, 416 of FIG. 3, whereby consecutive points, 6A, 6B, 6C, 6D, . . . along trajectory, 528, are allocated into vector data sets of (lat1, long1), (lat2, long2), (lat3, long2), (lat4, long4) etc. using the different vectors constructed thusly, ratios of the difference in latitude vs. the difference in longitude can be made. For decreasing slope of the vectors, i.e., 602, 604, 606, . . . a right turning motion is deduced. In other examples increasing ratios of the slope of the vectors a left turning motion is deduced.

Additionally the magnitude of the curvature is calculated by mathematically determining construction lines between certain consecutive points 13A, 13B, 13C, 13D etc., and mathematically determining the bisecting lines of such, 608, 610, 612, . . . . Using the equation for a line, y=mx+b, and replacing y with latitude, x with longitude, m with the formerly determined slope, and b the y (latitude) axis intersecting point, the vectors from points 6A, 6B, 6C, 6D, etc, are substituted to determine the intersection point, in this case essentially point 620. By mathematically determining the length of line 608, i.e., 608′ one can deduce the curvature of turn. Turn curvature, including direction of turn, is supplied to other functions at FIG. 10D step S54. An indication of the commencement of a turning event is used to begin assessment of whether the portable wireless device motion is indicative of use on the operator's side of the vehicle or otherwise.

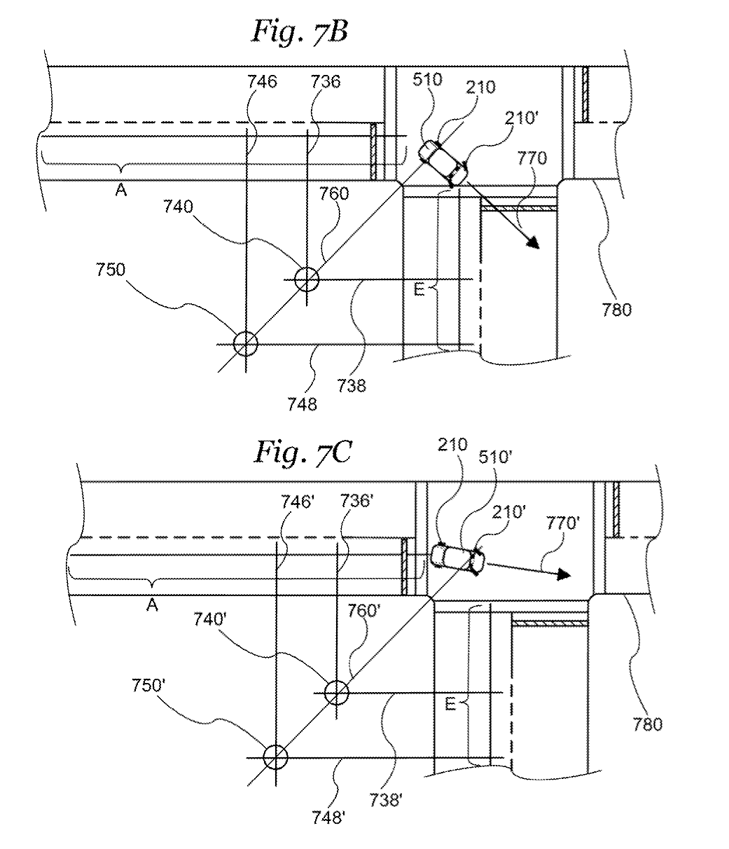

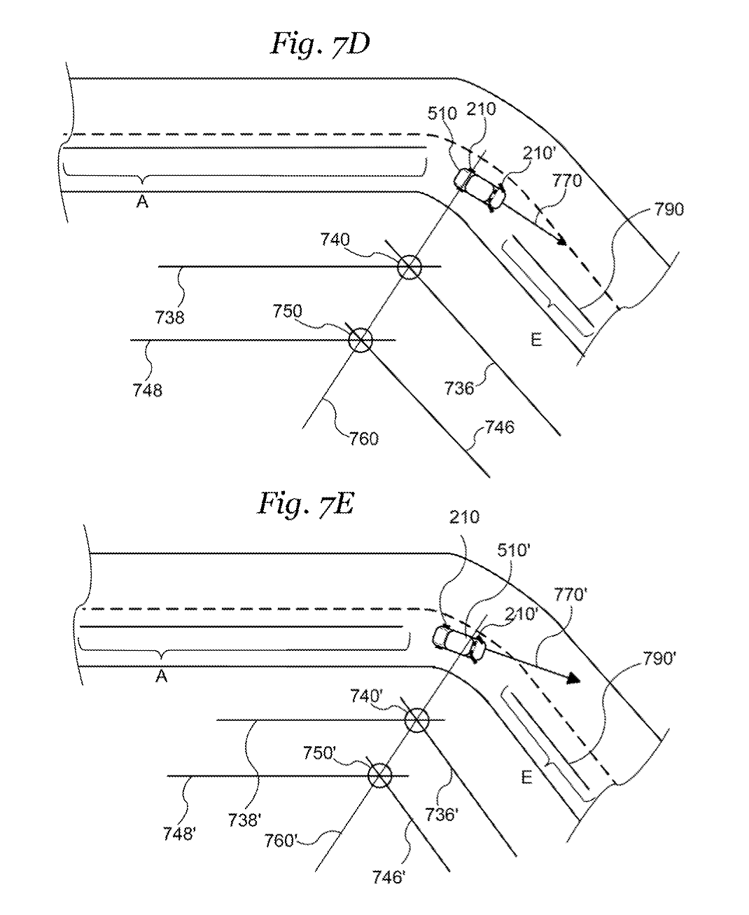

FIG. 7B shows the vehicle during the turn 510, has wheels, rear, 210 and front, 210′ has intersecting roadways 780, overlaid with vehicle trajectory entering the turn, A. Vehicle trajectory after the turn is shown as E. Post processing 50-foot construction lines, 736, and 738, intersect at 740. Post processing 100-foot construction lines, 746, and 748, intersect at 750. The post processing construction line, 760, constructed from passing through location points, 740, and 750, is extrapolated to the intersection. The orientation of vehicle, 510, as its rear wheels transit the construction line, 760, indicates a heading, 760, that is essentially perpendicular to the construction line.

FIG. 7C shows an example turn where the user is located in the vehicle front.

The above discussion applies with the exception that construction lines are now the same references except primed, i.e., 736 becomes 736′ and so on.

Vehicle 510′, at the point of having its front end transit the construction line 760′, has a substantially different heading, 770′, which is markedly different in direction to that of FIG. 7B′s heading 770. It is noted that by detection of the transition point an estimate of the difference between the heading and the construction line is made. Portable wireless device headings markedly different than perpendicular to the construction line, 760, cause an instance of front seat location to be signaled.

FIG. 7D shows a portable wireless device trajectory indicative of being in vehicle, 510, rear seat, as it enters a turn of other than 90 degrees heading change. Nomenclature from FIG. 7B applies. Processing from FIG. 7B applies.

FIG. 7E shows a portable wireless device trajectory indicative of being in vehicle, 510′, front seat, as it enters a turn of other than 90 degrees heading change. Nomenclature from FIG. 7C applies. Processing from FIG. 7C applies.

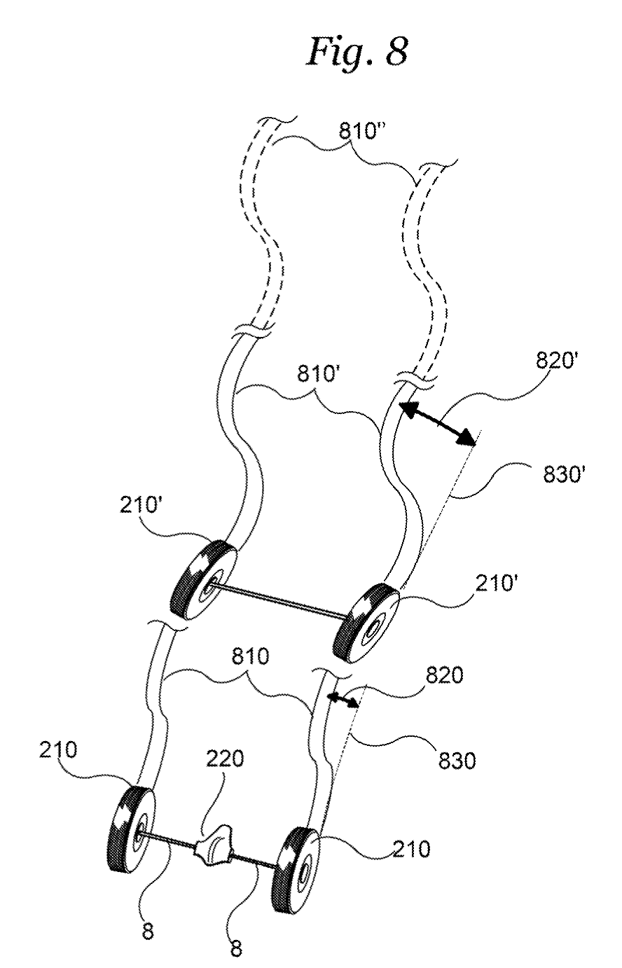

FIG. 8 shows the wheels of FIG. 2, and expected traces of turns in alternating directions.

The initial direction the rear wheels, 210 are headed is shown as 830. The initial direction of the front wheels, 210′ is shown as 830′. During this example turn, due to the steering input, the rear wheels follow tracks 810. The front wheels follow tracks 810′, and ultimately follow tracks 810″.

The amount the rear wheel heading changes during the turn is shown as 820.

The amount the front wheels change in heading, i.e., steering input, is shown as 820′

The amount of turn, and consequently lateral translation, for the front wheels, 210′ exceeds that of the rear wheels, 210. If the path of the vehicle was to have a trajectory of continual turns to one side and then the other, 810″, the amount that the front of the vehicle, and by extension, the amount of a portable wireless device situated closer to the vehicle front than rear would have a greater amount of deviation from the average position (of a line down the middle). This is detected and compared against an a priori settable known threshold parameter.

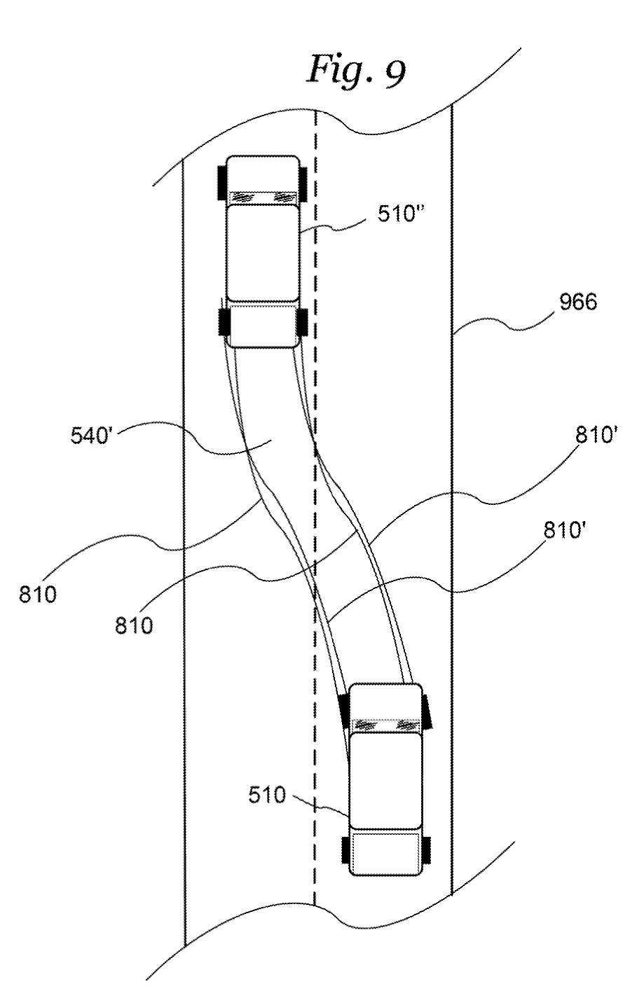

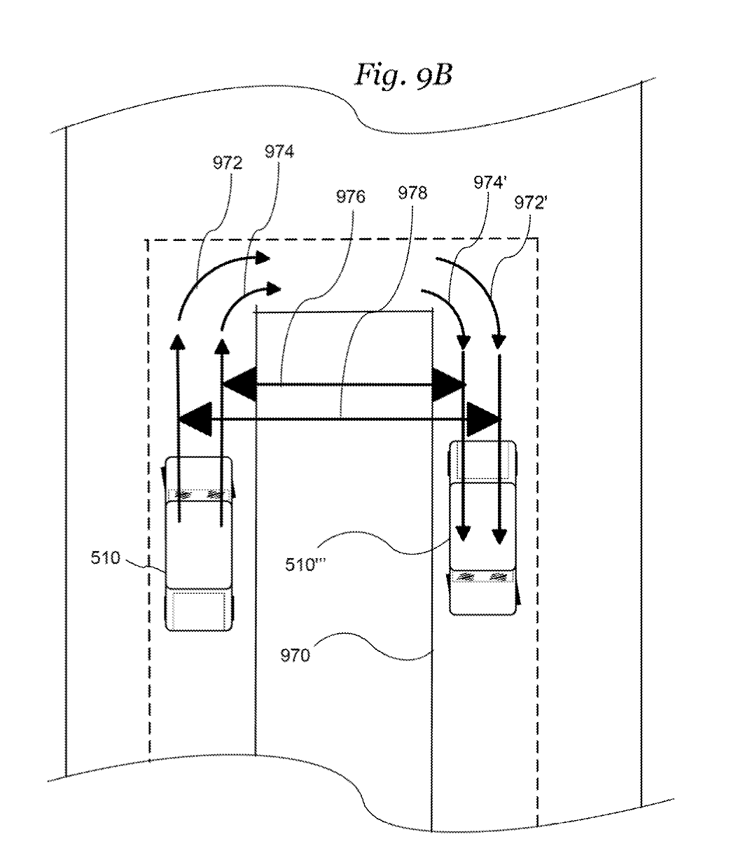

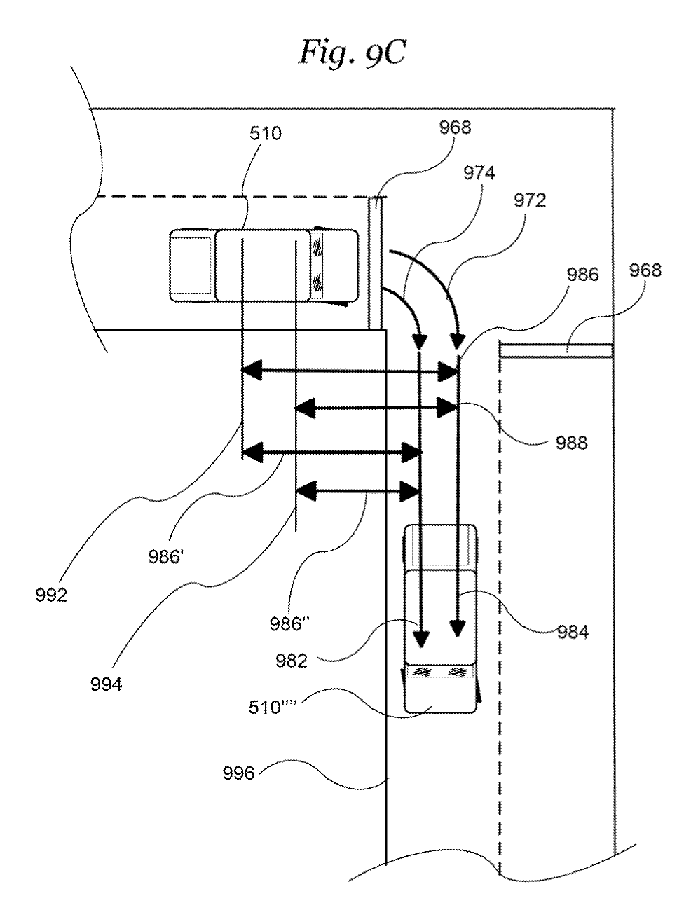

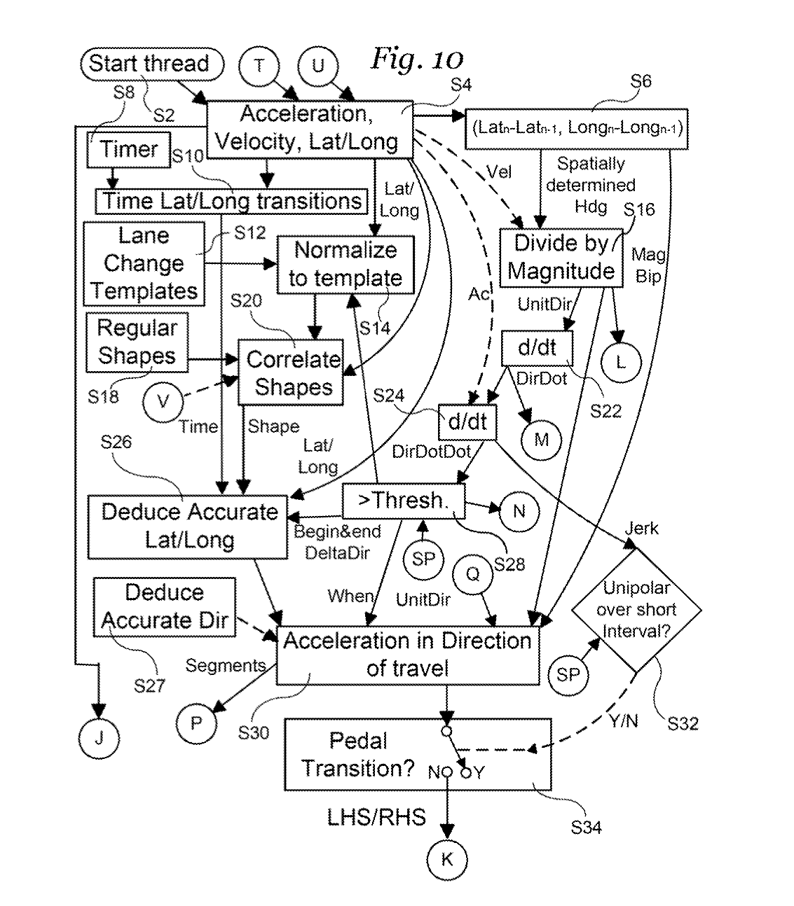

FIG. 9 depicts a vehicle profile during lane change. The profile is recorded with high precision real time location information of the previous discussion, as the vehicle passes from first location, 510, in one lane, to second location, 510″, via trajectory 528′, along roadway, 966. The wider trajectory of the front wheels, 210′ exceeds that of the rear wheels, 210. Memory element 414, (FIG. 3), contains pre-recorded average shaped trajectories of lane changes in both directions. The high precision recording of the transit above is scaled to match that of the pre-recorded template, of Step S12, (of FIG. 10) both in length and in width at Step S14, of FIG. 10. By performing a correlation between the discrete elements of the recorded data against that of the template an estimate of fit is obtained. Processor, 416, of FIG. 3, performs a correlation against each of the scaled recorded lane changes, against each of the four cases of:
left to right lane change front seat,
left to right lane change rear seat,
right to left lane change front seat, and
right to left rear seat lane changes, and records figures of merit for the fit against each.

The highest correlation is allocated to the case which has the lowest number, if done e.g., root mean square (RMS), regression methods, or the like, etc, by processor, 416. Processor, 416, (FIG. 3) uses the value directly as an instance of fore/aft depending on the case with the higher correlation. Instances allocated fore vehicle location are accumulated and decremented per each lane change that fails the above test. Once the accumulated value exceeds a predetermined, or network supplied threshold, processor, 416, inhibits services, based on such, or does so in conjunction with a sufficient number of detected instances accumulated, without a sufficient number of failures of detections, of operator's station side of the vehicle.

It is an aspect of this disclosure that the most plausible of fore/aft, and the most plausible of left/right determination is made by comparison to one of relative position, acceleration, jerk, and added into the input IN1′, of processor, 416, of FIG. 3. It is an aspect of the present disclosure that comparisons of portable equipment position compared to a particular location in lane from predetermined values, is made and a determination of the most plausible location in vehicle is determined and acted upon. It is an aspect of this disclosure that these values are network provided.

Explanations concerning FIGS. 9B and 9C, assume the use of an extensive data base of cultural information, collected using the navigational and orientation element, 414, of FIG. 3, or stored a priori, are available, from a network, or loaded from a CD, (not shown).

FIG. 9B depicts a vehicle on roadway, 970, undergoing a change of direction. The element 416, (FIG. 3), compares the known lane distance between vehicle initial location, 510, against known lane position 510′″ from data available to the arrangement either stored in memory element, 414, (FIG. 3) or network provided and using the information to discern portable device use, or intended portable device use of a vehicle operator's position to that of a non-operator position. In the example shown, placement of the portable wireless device on the right side of the vehicle, causes location information to be of an ‘inside of turn’ nature, shown as, 974, and 974′. Placement of the portable wireless device in the left side of the vehicle causes a displacement of an “outside of turn” nature, shown as 972, and 972′. In a simple example, after two such turns, although not necessarily adding to 180 degrees, a determination of position in lane can be deduced from the difference in the displacement, i.e., the inside of turn case, 976, or the outside of turn, case of 978 and being assessed as such. For cases wherein the total of heading change before the turn(s) doesn't add to 180, the estimate of position, of necessity, takes into account a measure of the location of vehicle positions, 510, and 510″ along the road segment, (which would be up/down location in FIG. 10D, not shown for clarity) as well as, the distances across the turn, 976, 978.

FIG. 9C, depicts a transit through an intersection on roadway, 996.

Vehicle initial position 510, at a stop line, makes a turn of essentially known radius, 974, inside of turn, or 972, outside of turn, leading to an approximate known departure location, e.g., 982, or 984, using a database or a database in conjunction with a known parameter, the distance from the known departure line.

Conversely it is also an aspect of the present disclosure that, using known information, e.g., the fore/aft position in the vehicle that the left/right information, i.e., 982, 984, can be determined/augmented, by resolving the location at which a vehicle may come to a stop. Details concerning extraction of intersection information are taught in patent application US20070263779.

Processing, 416, (FIG. 3), in conjunction with information stored in memory 414, (FIG. 3), overlays construction lines 992, and 994, as well as measured values of 988, 986, 986′ and 986″ in similar fashion to that of Step S56 (of FIG. 10B). Processor, 416, of FIG. 3 takes the difference between known transit location leaving the turn and the known resting spot at the stop line, 968. Lines representing different scenarios vis-à-vis location of portable wireless device within the vehicle, have different expected lengths, especially when one determination is known already, i.e. fore/aft question, or left/right, wherein the remaining deduction is to be made i.e. left/right, or fore/aft, respectively, This is done by processor, 416, of FIG. 3, comparing the segment length 968, to 988, 968′ and 968″ after elimination of the non-usable cases.

### Examples:

i) It is known that the user is in the left side then throw away the cases of 986′ and 986″ comparison, and resolve the length to be more plausibly one of 988, or 986 on the basis of length,
ii) It is known that the user is in the back no further processing is needed
iii) It is known that the user is in the front then throw away the cases of 986 and 986′, determine which of 986″ or 988 values from the database, is closer to the value supplied from the navigation and orientation sensor, 412 and make the deduction based on such, i.e., 988 is assessed as being the operator's station, and loss of mobile services is initiated, Step S20, of FIG. 10.

It is noted that the forgoing example is that which would be compatible with a left hand drive such as would be found in North America. A similar situation is used for right hand drive vehicles, such as in the UK. Except with the necessary use of left for right and vice versa.

It is noted that although the example is one of 90 degree angle turn that turns of other angles are analyzed taking into account the additional consideration of the distance traveled after the turn along segment E, wherein processor, 416, of FIG. 3 compares the segments 988, 986, 986′, 986″ pre distance from the intersection, (from a database stored in memory 414, (FIG. 3)) depending on whether the overall turn angle is obtuse, or acute.

FIG. 10 is the first part of a flow chart depicting software control, and data flows, during processing by the main threads of the processor, 416, of FIG. 3, except wherein other software threads have been discussed in other places in the disclosure. The thread starts at Step S2, continuously updating vehicle motion from navigation and orientation element, 412, (of FIG. 3), with data streams, T, and U, entering the software processing sequence at Step S4, or supplied by portable wireless device, 422 (of FIG. 3). The source and derivation of these streams is addressed at a later point in this disclosure. U is a precise derivation motion based on integrated Doppler of the RF phase. T is less precise, but required to ascertain one of the general geometry involved for deductions of what changes in the RF phase is to be interpreted as, and used as an initial starting point for determination of indications of motion, acceleration, position, velocity, relative velocity, or jerk. Acceleration, attitude, velocity, and/or lat/long information from Step S4, are sent to Steps, S6, S10, S14, S16, S20, S24, and S26. Motion information provided by Step S4 to Step S6, is subtracted from information given previously to Step S6, giving an estimate of spatially determined heading to Step S16, as well as magnitude of velocity given to Step S30. Although system timing information may enter the system in a myriad of ways, in this example, system timing information enters the system at Step S8, where it is passed to Step S10. At Step S10 latitude/longitude information transitions are clocked by timing information given from Step S8. By tracking the timing of the information Step S10 keeps track of the time against each of latitude, longitude, (and optionally altitude) transitions permitting tracking of more refined motion information for regular trajectories. Determinations of regular trajectories, when possible, are bolstered by taking the cross product of the vector of approach, (item A in FIGS. 7B and 7C) with the present direction of motion, as determined at Step S16 to be discussed shortly. Determinations of Local up or down will be discussed later. Results of the cross product calculated at Step S57, of FIG. 10B. Step S57, (explained in more detail later) has zero magnitude for essentially straight travel, a positive Z for essentially right turns, and negative Z values for essentially left turns. Optionally using an indication of the direction of turn from Step 57, of FIG. 10B, Step S20 takes the normal to the incoming segment, A, (of FIG. 7B), by taking the cross product of A, (expressed as (deltaLat, deltaLong, 0), crossed with the unit Z direction (0,0,1). This is converted to a line, i.e. latitude=longitude*slope+intercept, for several different segments (in the classical sense), of the arc of the curve. By solving the two equations in two unknowns, the processor, 416, of FIG. 3, at Step S20 of FIG. 10, is able to ascertain the center of the curve for a minimum of two segments (again taken in the classical sense). By tracking however many of these segments happen to resolve proximal to this point determined by previous segment pairs, Step S20 renders an indication of those segments that are part of circular motion. At Step S20, motion determined to be linear, by having many regularly spaced lat/long transitions (within certain error limitations), a zero cross product, or otherwise, is best matched by linear regression, from which the device motion is ascertained and timed against to reveal accurate position information from the clock. At step S20 motion determined to be circular by a plethora of circle center points proximal to a center point previously determined (again within error limitations), data just prior in the stream, one can deduce the position of the circle relative to the lat/long grid by the timings of the lat/long transitions. As the portable wireless device transits the circular path, the most rapid changes in latitude, during no transitions of longitude represent North/South motion, depending on direction, and so on. For transitions of equal time spacing, motion along directions of 45°, (at the equator) would be implied. Smaller arcs are deduced using known changes in the sine and cosine functions and the latitude of the user. The conversion of latitude into distance is direct. One arc minute of latitude is one nautical mile or 6080 feet. The conversion of Longitude requires knowledge of the latitude to adjust the amount of distance allocated to a minute of longitude. Longitude is allocated 6080 feet per arc minute multiplied by cosine of Latitude. Heading, as measured clockwise from North, is determined by arctan [deltaLatitude/deltaLongitude]. Using knowledge of the direction of travel and several lat/long transition timings the circular motion duration is detected and mapped to the lat/long grid, at Step S26, of FIG. 10. Slight difference in technique offers very accurate determination of direction, Step S6 of FIG. 10.

It is understood that filtering, at Step S26, for an essentially regular cadence of lat/long transitions a linear segment of trajectory is detected. It is understood that filtering for sinusoidal cadences of latitude, optionally alternating with co-sinusoidal cadences of longitude, or vice versa, the placement of segments of circular motion is detected and located at Step S26. It is understood that this technique is extended also to the detection of exponential, or trajectories along other regular curves.

Other shape determinations are made using a library of known templates of circles, lines, curves, exponential or otherwise, and performing a correlation of the path as recorded against the proffered template. Latitude/Longitude, or accelerations from paths of very high correlations are used at Step S30, while others are filtered out and rejected at Step S20. Other techniques exist, wherein the determination of lat/long transitions are mapped piecewise linear and curve fitting is applied in post processing with curves of the least order of magnitude that fit the resultant piecewise linear mapping discussed earlier within a certain error limit.

Step S14, records lane change maneuvers, scales the lane change maneuver in elapsed time, and scales the maneuver across lane width of the transition, to that of the lane change templates recalled from memory by Step S12, upon prompting for the need to do so, from Step S22. Step S14 executes a spline function for these scaled recorded values causing an even distribution of the discrete values along the trajectory collected. For values of dHeading/dTime arriving at Step S22 that exceed the threshold value from Step S28, Step S26 makes a deduction of the segment (segment can mean circle or curve as well as line for this discussion) characteristics and passes it to Step S30, i.e., S26 outputs an object concerning a segment and of a heading of, or radius of curve, and S14 outputs a normalized recording of travel scaled to that of the template, i.e., throws away, or interpolates, or rescales the lane change to that of the template in the vehicle longitudinal direction by determining the completion of lane change again by the signal/object passed by S12, such that they span the same lane width and the same linear distance, or optionally velocity, acceleration, jerk, or speed record vs. time during the lane change.

Step S10 times transitions in motion indications sent from navigation and orientation entity, 412, (of FIG. 3), via Step S4, using timing information, from Step S8, prosecuted by aspects of a real time operating system (RTOS), from an accurate hardware timer, or from a network supplied entity. This is supplied to Step S20, where the timed transitions, qualified by being associated with a known shape, from Step S16, is used to deduce an accurate estimate of lat/long as a function of time. Prompting to perform this deduction is supplied by the peaks, negative or positive, from the second differential of change in heading with respect to time taken from the estimate of heading, previously discussed, at Step S6. Unit direction is derived by taking the spatially determined heading and dividing it by the magnitude of the spatially determined heading as calculated by Step S16 and output this unit direction value to Step S22. An indication of a change in heading is determined at Step S22 by taking the time differential of the input unit direction and outputting it to Step S24. Indication of points in time having a change in the rate of change of direction is determined by step S24, which takes the second differential of heading with respect to time. An indication of when there is a change, in the rate of change, of direction is determined by exceedance of a system parameter, SP, threshold value at Step S28.

Receiving a trigger from Step S28, as to when a deduction is warranted, Step S26 uses details of the trajectory segment, supplied by Step S20, and the accurate time of lat/long transitions, supplied by Step S10, to make a determination of the accurate placement of the segment against the latitude longitude grid. Step S30, also receiving an indication of the beginning and end of the trajectory segments from Step S28, considers the placement of the regular segments. For transitions from a linear segment to a circular path, of from a circular path to a linear segment, the curves, for cases where the portable wireless device is at locations other than the vehicle center of rotation, Step S30 determines that the segment transition is most likely either too short (inside of the turn), or too long (outside of the turn). Step S30 assesses the cases where the transition is too short as being one of deceleration, and assesses cases where the segments are too far apart as being an instance of acceleration.

Alternately Step S30 compares lat/long transitions during the curve, to those of the linear segment making a determination that the linear segment represents velocities greater than those of the circle or vice versa. In such alternate case, Step S30 makes a determination based on knowing whether the straight segment or the circle came first and whether that therefore corresponds to an acceleration before or after the turn, and in turn, whether the unit is therefore on the vehicle right side or left side.

Step S30 is supplied indications of heading from either Q, from Step S16, or from Step S52, as well as, an indication of magnitude from Step S6. In an optional alternative, triggered by an indication in the change in the rate of heading change, coming from Step S28, Step S30 takes the first time differential of the indication of motion supplied by Step S6 and then takes the dot product of this and the unit direction from Step S16. This offers an indication of acceleration in the direction of travel. For the purpose of this discussion trajectories along a regular curve or linear trajectories are both taken to be segments. In alternate embodiments Step, S30, supplied with indications of acceleration, velocity, lat/long, jerk, or position from navigation and orientation entity, calculates the component of jerk in the e direction of travel. At Step S32 jerk above, a threshold value is further evaluated to be one of a bipolar jerk, or a uni-polar jerk (In addition to FIG. 10, see FIGS. 6 and 6B) and allocates a uni-polar jerk to be one of operator input, and bipolar jerk to be that of subtle changes in velocity profile brought about by steering inputs. This is optionally used in conjunction with changes in heading exceeding a threshold from Step S22, i.e., if heading now starts to change and wasn't changing until now, this is likely the start of a turn and it is time to look at the component of forward speed for this subtle indication of jerk. Alternately if heading stops changing, and until now was changing, this is likely the end of a turn and the time to look at the component of forward speed for this subtle indication of jerk. An alternate implementation has heading changing relatively rapidly for which Step S34 assesses this as accelerator pedal input induced acceleration such as one might expect at some point in a turn, for which Step S34 filters off the evaluation of acceleration deduced at Step S30, as immaterial. By this or the original method of filtering off single polarity jerk indications operator pedal inputs, such as the resumption of acceleration at the point of depressing the accelerator, extraneous determinations of acceleration in the direction of travel are removed from the running average filter input at Step S30. Optionally Step S30 takes turning rates above a threshold into account to (further) qualify the acceleration as part of the resumption of the application of power during a turn.

It is understood that any estimations of jerk are optionally determined from acceleration, velocity, speed, position, or directly supplied from navigation and orientation entity as jerk natively, and used directly or a component of such is used directly at Step S24. For the following discussion use is taken to mean: use, or intended use, of a portable wireless device.

For cases of positive accelerations prior to a right turn, an instance of being used on the left side of the vehicle is assessed. For cases of negative acceleration prior to a right turn, an instance of being used on the RHS use is assessed. For cases of positive accelerations prior to a left turn, an instance of right side use is assessed. For cases of negative accelerations prior to a left hand turn an instance of left side use is assessed.

For cases of positive accelerations just after a right turn, an instance of being used on the right side of the vehicle is assessed. For cases of negative acceleration just after a right turn, an instance of left side use is assessed. For cases of positive accelerations just after a left turn, an instance of left side use is assessed. For cases of negative accelerations just after a left hand turn an instance of right side use is assessed. Step S28 keeps a running average of the assessments of being on the driver's side decrementing the average for each case that is assessed to be non-driver's side. Driver's side is determined to be the left side, or not, based on a system parameter SP (Left hand drive for N America, right side for the UK etc.), supplied by Steps S50, (FIG. 9B), if available, and from memory, 414 (of FIG. 3), by Step S54, (FIG. 9B), if not, in conjunction with a threshold value that must be exceeded (e.g., need two more rights than lefts, or e.g., need twice as many lefts as rights in the last twenty times), supplied from the same sources, i.e., Steps S50 or S54. In conclusion the output of Step S34, (FIG. 10), K, is a qualified indication of portable wireless device placement in either the right hand or left hand side of the vehicle.

FIG. 10B depicts processing for Fore/Aft determination.

Referring to FIG. 10B, indication of motion streams, T, and U, supply Step S4 with at least one of: location, acceleration, velocity, attitude, jerk, speed. Optionally at least part of these streams come from portable wireless device, 422, of FIG. 3, as well as data stream, T from FIG. 3D and FIG. 3E.

This information is post processed at optional Step S38 to derive heading information or supplied directly to Step S52, via Stream L, along with heading information optionally from alternate sources, S36, S42, S44, S46, S48, used severally, or collectively, Step S52 makes a determination of heading, Q, and passes this information stream to Steps S56, S60 and S66, as well as, Step S30 of FIG. 10. Setting Z=0, if altitude is unavailable, using (lat, long, Z) and by taking the cross product of a trajectory stored at Step S56, previously supplied by Step S4, and a presently supplied trajectory, Step S56 makes an estimate of turn. This is optionally alternatively done after a prompt, N, is received from Step S28. A positive indication of heading change signaled from Step S52 to Step S56 is assessed as being complete at the instance of signal, N, (the change in the change in heading), returning essentially to zero. After waiting approximately 100 feet distance, Step S56, computes the points 736, 738, 746, and 748, or points 736′, 738′, 746′, and 748′ to place line 760, in a data entity or struct corresponding to the elements of FIGS. 7B, 7C, 7D, and 7E.

Using zero for the Z (up) dimension for the input vectors, Step S56 having stored the data from the approach takes the two dimensional differences in latitude and longitude of approach A (FIG. 7B), and performs a cross product (at Step S57) with the vector indicating present heading, from either Step S52, any of the heading inputs, or using the output of Step S38, which is also passed through Step S52 to Step S57. Step S57 has a positive Z (upward) component for right turns and a negative for left turns, in turn supplied to Step S56 for use in placing the 50′, 100′ and 760 lines. Optionally the output of Step S57, V, is supplied to Step S20, (FIG. 10), where it is used to supply one of: a handedness, a presence of turning, in the determination of curved trajectories. Step S20, of FIG. 10 accumulates these instances of the cross product from Step S57, of FIG. 10B, converts the directions of theses lines, (from their longitude=slope*latitude+intercept point format), and works the two equations in two unknowns to determine the point of intersection of the two lines perpendicular to the curve segments (segments used in the classical sense). In this optional embodiment, Step S20, of FIG. 10, accumulates these intersecting points to make intelligent estimates of circles and curves to try against the incoming data stream at Step S20, of FIG. 10.

Referring to FIG. 10B, Step S56 signals Step S59 with the latitude and longitude location of line 760 from FIGS. 7B and 7C. By using once again the format Longitude=slope*Latitude+intercept point for both line 760 and the line representing the present latitude/longitude supplied from Step S4, Step S59 makes the determination of point of crossing the 760 construction line, when the present position fit matches the equation, within limits. This determination is made either in real time for known intersections, or post processing, and is signaled to Step S62. Determinations of portable wireless device heading, from Step S52, compared to present track made good, from Step S62, are made in various optional embodiments at various times throughout the turn. Step S64 assesses instances greater than threshold value supplied from one of system parameters, SP, to be of front seat location and are accumulated in the running average filter at Step S68.

Instances determined by Step S64 to be less than the threshold are assessed as instances of back seat and serve to de-accumulate the running average accumulated at Step S68.

In another stream leaving Step S52, heading changes are determined over a short time interval, e.g., 80 ms, or some other integral multiple of the radio navigation system epoch time, at Step S52 are passed to Steps S60 and S66 where it is determined if these transient lateral accelerations exceed thresholds, such as the motion 810″, of FIG. 8, or not. Determinations of the magnitude of heading change rate, or magnitude of lateral motion, essentially lateral orientation data, less than a low valued threshold at Step S60 are assessed as being on a large vessel and thus not inhibited. To make this lateral acceleration estimate, Step S4 providing post processing Step S52 with acceleration data, makes a determination, at the point at which the portable wireless device senses an acceleration of sufficient duration as to be indicative of placement in a vehicle that is accelerating from a stopped condition, i.e., using data from vehicle acceleration up to speed, and integration of orientation thereafter, the sensor input to Step S52 permits S52 to determine motions that are perpendicular to this. Magnitude of this lateral motion, (810″, FIG. 8), exceeding this low value threshold and below a higher threshold value, at Step S66, are assessed as being back seat and are passed ahead to Step S68 for de-accumulation as such. Exceedance of the higher threshold at Step S66 are assessed as being instances of front seat use and are passed to Step S68 for accumulation of such. Step S68, instances of being front or rear seat are passed on as data stream R to Step S86, of FIG. 10C.

Network parameters are optionally input by portable wireless device, 422, (of FIG. 3), at Steps S84 and S86, of FIG. 10C

FIG. 10C depicts the schematic presentation of the software data and control flow of the device of FIG. 3, continued. Indications of acceleration, velocity, lat/long, speed, and/or jerk, J, are provided to Step S94 for determinations of essentially stoppage. Using system parameter SP, i.e., for this system parameter North America is 1, Britain/(˜Former British jurisdictions) is 0, to qualify the left side/right side instance, K, Step S76, assesses the instance, K, as driver's side for accumulation in running average at Step S80. Determinations to the contrary are signaled to Step S80 for de-accumulation. The output of the running average is signaled to Step S84, where a statistically significant determination of driver's side operation is made and passed to Step S88.

Fore/Aft instances, R, from FIG. 9B, both positive determinations and negative determinations, as well as, override signals, are signaled to Step S86 where instances of front seat is optionally made based on magnitude of the determination. This second running average is compared to a system parameter value indicating statistical significance, exceedance of which is signaled to Step S88 where in conjunction with the determination of statistical significance levels indicative of driver's side operation proximal in time to the determination of front seat are logically ANDed and used to at least one of: inhibit mobile device services, inform user, impede operation for a penalty period provided the user remains in motion and not using the device in hands-free, or impede operation for a penalty period provided the portable wireless device remains in motion, per Step S94, and using the device in hands-free mode. To prevent a passenger seat device being used hands-free remotely from the operator's location, it is understood that for velocities exceeding essentially stopped, the hands-free aspect of the device is impeded, or inhibited.

FIG. 10D shows a thread for refining the latitude and longitude based on transition times.

Start of thread, step S132, is executed optionally as a background process and is used to exploit a relatively fast clock to make refined determinations of latitude and longitude. Once started at step S132, the thread executes to steps S134 and S136. For step S134, whereupon detection of a latitude transition the transition time from step S137, is stored in step S138, from this and previously stored transitions exact latitude is deduced at step S142. Similar treatment of longitude can be made using steps S136, S140, S146, using time from step S137, offering an indication of time refined Longitude. Ongoing Latitude and longitude transition times from steps S138 and S140 are supplied to step S150. Step S150 compares the magnitude of the time interval between latitude transitions to the magnitude of the interval between longitude transitions. For cases of constant ratio, step S150 informs output step S154 to inform other function blocks of essentially linear trajectories. For cases of changing ratio, a thread corresponding to the description for FIG. 6C is executed, rolled up into a function referred to as determine curvature, FIG. 10D step S152.

Step S52, once complete informs step S154 to supply this signed value of curvature to other function blocks.

FIG. 11 depicts an alternate method of deriving the acceleration of the portable wireless device of FIG. 3, (and by extension those of either FIG. 3D, or 3E, etc.) wherein satellite geometry is exploited in conjunction with the second rate of change with respect to mobile wireless device internal oscillator time of the relative code phases of the incoming satellite data stream. No restriction against other processing, such as: running averages, accurate latitude/longitude timing for regular functions such as lines or curves, integrated Doppler measurement, where appropriate is implied, for deduction of operator intention to use, operator use of portable device. SV, 950, transmits signal, 960, 960′ to device of FIG. 3, 424, which receives said signal. Radio Frequency (RF) Signal has characteristics of frequency, phase, bandwidth, data stream, encoding etc.

Using the known, a priori characteristics of frequency and bandwidth, for a plurality of Bands (L1, L2, L5, E1, E2, E3, . . . ), and for a plurality of Code Division Multiple Access (CDMA) channels, i.e., different SV's, navigational and orientation element, 412, (of the circuitry of FIG. 3) receives the signal, and mixes to base band. At base band frequencies, the signal is processed: initially for RF signal acquisition, for S/A code acquisition, S/A code tracking, for Doppler removal, for RF signal phase information, for code phase information, and for de-spreading and data stream capture.

Exploiting a plurality of receiver channels, a plurality of CDMA code channels, simulating the code channels and correlating with the code channels, dedicating a receiver finger to the processing of each, the processing element establishes an initial estimation of geometrical orientation with respect to the satellite vehicles, from the phase delay differences of each of the code epochs during code tracking, optionally with integrated Doppler measurement and/or multi-path mitigation.

Processor, 416, of FIG. 3 exploits the initial estimation of the relative geometries of the SV and mobile wireless device to deduct Doppler shift calculated a priori from data stream information. The navigation and orientation element, 412, of FIG. 3, further tunes the RF signal to this anticipated “Doppler removed” frequency for each receiver finger. This is done for more than one channel, (i.e. for a plurality of channels, e.g., GPS, L1, L2c, L5). Per SV, navigation and orientation element, 412, further extracts the difference in pseudo-ranges of the plurality of channels, e.g., GPS, L1, L2c, and L5. Tracking these pseudo-range differences the navigation and orientation element, 412, records these against the rough estimate of location and time of day, year, time in sunspot cycle, and any other independent known parameter of Ionospheric activity. From this record, or data known a priori and stored in a data element aspect of the navigation and orientation element, 412, the estimate of location is further adjusted.

Tracking the changes in phase of the RF signal, by navigation and orientation element, 412, very accurate estimations of pseudo-range are available. Processor, 416, of FIG. 3, using the rough estimation of orientation to a plurality of satellite vehicles and timing source, (contained internal to 412, as applicable) to ascertain an estimate of orientation with respect to the SV's by determining the location of intersection of hyperbolas of position, taken from the difference in time of arrival of any two satellite vehicles, and optionally an accurate reference clock, the surface of the geode, or any suitable combination thereof.

Navigation and orientation element, 412, (FIG. 3), further makes available, acceleration, jerk, displacement, speed, and velocity to processor, 416, of FIG. 3 by converting the coordinates to Earth Centered Earth Fixed Coordinates (ECEF), or for the cases of acceleration, jerk, speed, and velocity, by taking the difference from prior processed information, over small time intervals, and converting it to ECEF, as required. Navigation and orientation element, 412, by tracking phase changes in the incoming RF signal, U, of FIG. 10D, and integrating, offers an indication of change of velocity to a fine degree, particularly when taken in reference to previous velocity. FIG. 11, depicts geometry with a heading circle, 942, with heading, 944, determined by navigation and orientation element, 412, of FIG. 3. Processor, 416, of FIG. 3 ascertains local zenith, or nadir from a cross product of the track leading into a turn and the orientation of a track leading away from a turn.

To determine the direction up processor 416, of FIG. 3, triggered with a change from navigation and orientation element 416, of FIG. 3, deduces that the user is in a turn. Processor 416, of FIG. 3, also calculates the direction of turn by using incoming values from navigation and orientation element, 416 of FIG. 3. Processor 412 calculates the cross product (A×E), where A and E are as defined in FIG. 6, or FIG. 6B. The dot product of the cross product thereby obtained is evaluated for several non-coplanar vectors. The vector evaluated to be the largest dot product with A×E, is taken to be the local zenith for the case of a right turn, as determined by a decrease in the slope of A (FIG. 6, or 6B)[=change in latitude/change in longitude] compared to the slope of E (FIG. 6, or 6B), as calculated from navigation and orientation entity, 412, of FIG. 3, navigation data.

The inverse cosine of the dot product of the vector taken to the local vertical with A×E (i.e., the vector cross product of arrival direction, specified in lat/long of A, FIG. 6, and the leaving direction E, FIG. 6) of the direction of arrival of the signal from e.g. extraterrestrial sources, such as GPS, GLONAS, or the like, processor, 416, obtains the angle from the incoming signal to the local vertical, per the RF phase difference between the receiver antennae. By subtracting this value from 90 degrees, processor, 416 of FIG. 3 determines the local elevation angle to the SV. The amount of acceleration applied in such case is the cosine of this angle. Estimates of acceleration, velocity, speed, location, are obtained by repeating this process for multiple such satellites.

In one embodiment data is extracted from GPS L1, (Course Acquisition, C/A) without the benefit of Ionospheric effect mitigation, or the benefit of RF phase determination etc, wherein the C/A is resolved into position determination, exploiting the benefit of clock adjustment to extract the best solution by weighing the spread of solutions from various SV pseudo-range solutions and picking the one with the least spread. Interference methods such as this are capable of real time positional accuracies in the centimeter range [Kaplan and Hegarty, page 397]

In one embodiment with suitable data available, optionally over a network, the portable wireless device determines all required information in relation to the cell tower network. Referring to FIG. 11, location of antenna element, 408′, antenna element now removed for clarity, in this example, receiving signal later in time (phase has increased), is considered to be further from the transmitter, 950, than location of antenna element, 408, antenna element now removed for clarity, by the distance shown as 958, in FIG. 11. As the portable device is typically not longer than a wavelength, the processor, 416, of FIG. 3, attributes this difference in phase to be less than one wavelength in physical length. The processor, 416, of FIG. 3, converts the phase into a physical length for the component of 954, (of FIG. 11) along path 960, (of FIG. 11). Processor, 416, of FIG. 3, determines the relative locations of the SV's from the decoded downlink data stream. Using this relative location of the different SV's, e.g. 950 of FIG. 11, in our example, processor means 416, of FIG. 3, determines the orientation of the portable wireless device relative to the SV's. This will be explained later on.

With normal use, changes in orientation of the reference antenna elements, at some point in time will happen to become equidistant to a given SV. Beyond this point any differences in phase sent to the processor are determined to be essentially due to change in orientation of the portable wireless device and are sensed as a change in path length, 954, from the SV's with adjustment for Ionospheric effects in certain embodiments.

In an alternate embodiment the acceleration, and jerk of the portable wireless device are determined from the changes in the determined differences in phase of the incoming radio frequency (RF) signal. This is done with an a priori rough indication of the geometry of the directions to the SV's.

In some embodiments, another antenna, 408″ is used in addition to the antennas, 408 and 408′, to have additional attitude information. In this case, antenna output is again phase adjusted and then fed into the phase comparator 890.

FIG. 11B shows one way of performing the necessary processing using velocity.

Satellite 950 is traveling with velocity 934. Satellite 934 transmits signal 960 to receiver 424, moving with velocity 932. Locations of equal phase are shown as 940 in FIG. 11B. In FIG. 11B receiver, 424, with adjunct device 417, and the remainder of the circuitry of FIG. 3, receives incoming signal. By tracking the carrier, the circuitry of FIG. 3C resolves the carrier center frequency per the description in [Grewal, 2007, chapter 3], the entire contents of which are hereby incorporated by reference. Additionally the center frequency, U, is made available to the processing element S4 of FIGS. 10 and 10B. Processing performed by element S4 further includes an integration function that outputs an indication of integrated Doppler. The value of the integrated Doppler is representative of the integral of the rate of change of the nominal center frequency of transmission plus the contribution from the change in the distance between the antenna phase centers of the satellite, at the time of transmission and the receiver at the time of reception. The Doppler shift can be up to several KHz above or below the nominal center frequency of the satellite. This Doppler value can be thought of as having a contribution from the satellite's motion, and a component from the motion of the receiver. The value of the Doppler shift is ascertained with very great accuracy. The contribution from the satellite may be relatively large compared to the contribution from the motion of the receiver, however the contribution from the satellite changes relatively slowly compared to that of the user. As a consequence the motion of the user can be very accurately obtained in very rapid fashion. [Grewal, 2007, pages 84-94] Accuracies to decimeter levels have been possible in real time with NASA's Global Differential GPS System since 2003, [Armatys, 2003]. Velocities can be calculated to a certain accuracy. It is the change in the velocities that are calculated very accurately. Using the satellite navigation message after decoding, and the integrated Doppler, the conversion is made to the change in user velocity in block 388 of FIG. 3C, as is known to any of ordinary skill in the art.

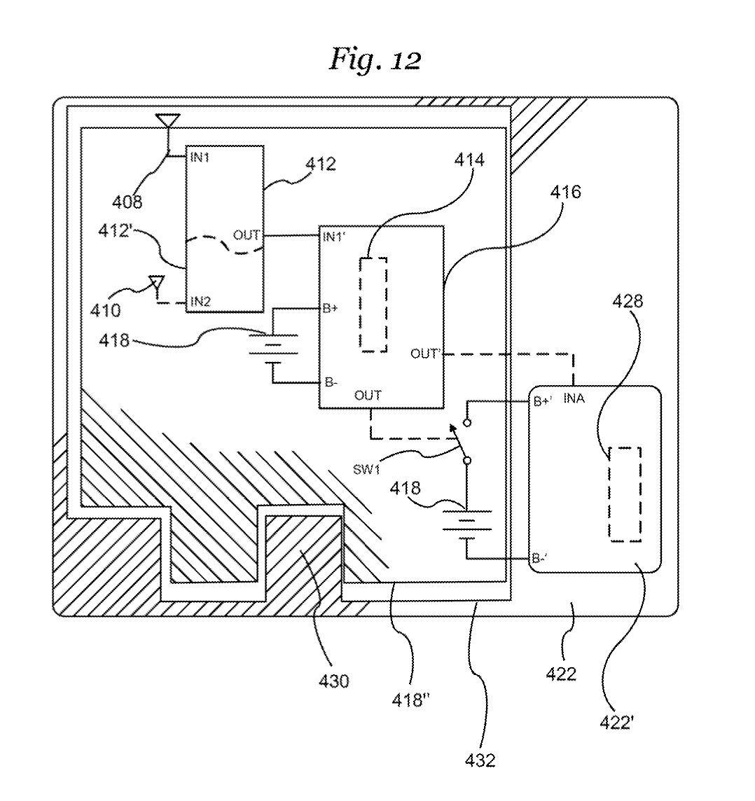

FIG. 12 is an alternate configuration of the device of FIG. 3. In place of disabling the speaker, microphone, or portable device, it disables the battery therein, preventing inappropriate use (i.e. handset on front passenger seat, with either wire or hands-free operation, or intended operation). Here FIG. 12 depicts battery compartment 432, mechanical keying, 430, battery proper, 418 shown in battery package, 418″. Switch SW1 is opened upon signal from processor, 416, of FIG. 3 output, OUT, for instances assessed to be proximal to the operator's station.

### DETAILED DESCRIPTION OF THE EMBODIMENTS

Referring once again to FIG. 3, a portable wireless device inhibitor device is illustrated according to a first embodiment as a device offering an inhibition of services of suitably equipped mobile device based on an accumulation of determinations of said mobile device being used, or intended to be used, in the front of a vehicle, and also being most plausibly on the operator's side of the said vehicle. This adjunct functionality of the said portable wireless device may be integrated with the main functionality of said mobile wireless device, such as with cell phone, computing device, or beeper functionality. It is understood that the said suitable equipment, implied is constituted as a 3-D heading entity, and a partial GNSS receiver with refined velocity entity. Other embodiments use different navigation and orientation entity elements.

In this embodiment, a determination of portable device acceleration is made, such as is illustrated in FIG. 6, wherein acceleration in the direction of travel is determined and found to be above a certain threshold at either the commencement, or the exit from a change in direction of motion azimuthally. Processor, 416, of FIG. 3, using displacement trend information available from e.g., a GNSS receiver, e.g., makes concurrent (on the order of a few minutes or less) determinations that indicate that most plausibly the portable wireless device is on the operator's side of the vehicle and most plausibly in the front of the vehicle. In an alternate embodiment, the determination of location is deduced by accurate timing, using clock, 411, of FIG. 3, of increments/decrements of lat/long with a previous determination that portable wireless device motion is regular, and either linear, or along a regular curve. In some embodiments this fitting is done post processing and a best fit is determined. Optionally this best fit, done by post processing, makes a determination of what the acceleration must have been, pre-entry to the curve, or pre-entry to the essentially straight stretch following.

In alternate embodiments refinement of displacement, velocity, acceleration, jerk, or speed, is by tracking of the RF phase, i.e., integration of the ingoing control signal to the NCO in a Costas Loop, FIG. 3C, FLL, or other PLL implementations.

Determining location by exploiting the accumulation of RF phase is typically plagued with difficulties in resolving the ambiguity of which particular wavelength is being examined.

Position determinations in the present disclosure, with a few noted exceptions, are adequately performed with lower resolution latitude/longitude solutions, or in some embodiments not performed. Acceleration, jerk, and velocity are important, however, but don't require ambiguity resolution pertinent to the use of RF phase determination for the reason of location determination, i.e., using the lat/long is not the only way to do it, velocity, or acceleration work equally well, provided a rough indication of orientation to SV's is available.

The preferred arrangement is shown in FIG. 3 using navigation and orientation entity to sense both the left/right location in the vehicle, as well as, the fore/aft location in the vehicle. In the preferred embodiment determination of fore/aft is made from a combination of weighted determinations.

The weighted determinations are made up of:
i) indications of sequential turns wherein the transitory value of the lateral motion of the device exceeds a threshold for such, known a priori and stored in memory 414, of FIG. 3,
ii) indications of a heading that exceeds a known a priori value for such stored in memory at the point in a turn as determined by the overlay of construction lines, 736, 738, 746, 748, and 760 of FIGS. 7B, 7C, 7D, and 7E
iii) indications from the correlations of curvature of a track in reference to velocity exceeds that of a known a priori threshold, as per FIG. 6C,
iv) indications from turns, and or locations, that the location in the vehicle is most probably on the operator's side of the vehicle, such as per FIG. 5B, FIG. 6, FIG. 6B, or FIG. 6C.

In the embodiment determination of left side/right side is made from a combination of weighted determinations of:
i) indications of longitudinal acceleration, coincidentally determined to precede, or succeed a path suggesting placement of the device on the operator's side of the vehicle,
ii) indications of an inappropriate amount of movement from a stop line, to a location in lane laterally based on known geometrical details of an intersection being transited and fore/aft information of such.

In the preferred embodiment lack of indications of high lateral motion are assessed by processor, 416, of FIG. 3 as being used, or intended to be used, in a large vessel wherein such use is authorized. In the preferred embodiment, a jack switch is used, (although not shown) to make a determination of non-hands free use.

FIG. 3 depicts the arrangement of an embodiment, with processor, 416, using memory 414, receives a stream of navigation states from navigation and orientation entity, 412, compares these to system time and deduces an estimate of the present navigation state. By deducting this from a previous navigation state an estimate of the previous velocity is optionally extrapolated to a fine degree. In an alternate embodiment, this data is accumulated from the values sent to the NCO of FIG. 9D.

Noting a change in heading, processor 416 compares lat/long changes against the system clock, and interpolates to curve fit. An estimate of the linear velocity along the curve is determined and compared to the speed during essentially rectilinear motion integrated over a relatively longer period. By comparing the change in velocity to the direction of turn processor, 416, determines whether the portable wireless device is used, or intended to be used, on the operator's side of the vehicle. For each indication of such, the processor, 416, of FIG. 3 stores an indication of such in memory element, 414. The arrangement of FIG. 3 continues to accumulate a plurality of such determinations. The arrangement of FIG. 3 also deducts any determinations to the contrary, in an ongoing fashion. A running average is taken of the number of such determinations compared to determinations to the contrary.

A threshold parameter is stored in the system parameter section of memory 414. Retrieving this constant, from memory, or from the network, via portable communications element 422, exceedance of this parameter is flagged as ‘operator side operation’ and noted for further use.

An indication of left side/right side location in the vehicle is sensed by short duration acceleration, essentially in the direction of portable wireless device motion, occurring in the time interval between an average vehicle velocity for a straight segment of roadway, and a turn. Another indication of left/right location in the vehicle is sensed by short duration acceleration essentially in the direction of portable wireless device motion, occurring in the time interval between a turn and a straight segment of roadway. This indication is sensed for cases just before, or just after, either a right or left turn. For turns of an essentially constant radius, when taken at essentially constant speed, the speed during the turn is essentially constant. The magnitude of the acceleration depends on vehicle speed and the radius of turn. The polarity of the acceleration depends on whether the portable wireless device is located left of, or right of, the center of rotation of the vehicle, in the plan form sense. The preferred implementation makes these assessments “on the fly”, in real time, as the unit transits the trajectory, by doing the assessments over a very short, but reliable interval.

Right turns cause a portable wireless device located on the right side of the vehicle to slow down during the turn, decelerating prior to the turn and accelerating just after the turn. Left turns cause a portable wireless device located on the right side of the vehicle cause the portable wireless device to accelerate prior to a turn and decelerate subsequent to the turn.

Right turns cause a portable wireless device located on the left of the vehicle to accelerate prior to the turn and decelerate just subsequent to the turn. Left turns cause a portable wireless device located on the left side of the vehicle to be decelerated just prior to the turn and accelerate just after the turn. In each of the foregoing turning scenarios, the direction of turn is determined by comparing the path made good by the portable wireless device. Direction of turn, V, is provided for use, by Step S57 of FIG. 10B. In some embodiments the comparison is made immediately the direction of turn is known, in other embodiments the comparison is made in post turn processing, shortly thereafter, with the resultant processing burden reduction

In other embodiments of the disclosure a running average is taken of the accelerations and decelerations in reference to turns to track the likelihood of portable wireless device use, or intended use proximal the operator's station. One such example of running average accumulates the number of cases of use proximal to the operator's station and decrements the same counter for cases determined to be distant from the operator's station. In some embodiments this is done in conjunction with determinations of use, or intended use in the vehicle fore. In some embodiments this is done solely by itself as the complete determination of use, or intended use of the portable wireless device.

Some embodiments use the information taken before and just after turns and use it in conjunction with information from a determination of fore/aft that is taken at a slightly different time in the vehicle trajectory, such as whilst turning at lower speeds, or the last acceptable trajectory for assessment. Some embodiments process the portable wireless device jerk to make the determination of acceleration. Acceleration used in determinations of left/right is essentially the component of acceleration essentially in the direction of vehicle motion, or the equivalent deceleration.

An alternate embodiment the arrangement determines that the most plausible side intended use is on the operator's side and that the most plausible location fore/aft is forward indicative of the operator's location.

An alternate embodiment determines that the location in the vehicle is in the front and most plausibly on the operator's side.

Yet another alternate embodiment determines that the location in the vehicle for intended use is on the operator's side and most plausibly in the front.

In some embodiments the velocity profile is compared to that of an otherwise constantly decelerating motion or constantly accelerating motion.

A thread being simultaneously executed makes a determination of the fore/aft location in the vehicle. Referring to FIG. 7, the amount of turn that the front wheels, 210′, undergo, 720′, exceeds the amount motion perpendicular to the direction of travel of the vehicle which the rear wheels, 210, undergo, 720. This is significant particularly at slower speeds.

In the preferred embodiment the contribution of a determination of fore/aft is made based on weighted values of two aspects of this determination:
1. a running average of values, that exceed a threshold, of headings different from perpendicular to portable wireless device motion at the apex of turn as determined by post processing lines such as shown on FIGS. 7B and 7C, and
2. a running average of values, that exceed a threshold, of amounts of left/right acceleration due to steering inputs detected as large lateral accelerations, inversely weighted by portable wireless device speeds, as determined to have a component of lateral motion based on the track made good around a turn, or otherwise.

The preferred embodiment, FIG. 3, navigation and orientation element, 412 further determines from heading determination means, for speeds below the threshold value, passed to processor, 416, of FIG. 3 and in turn stored as a system parameter, in memory, 414, that the heading changes experienced exceed the expected value, as determined from a running score. Determinations of front seat are accumulated. Determinations to the contrary are deducted from this running score value. Exceedance determination above the system parameter is assessed as ‘front seat’ operation.

It is noted that operation in operator positions and in large vehicle contexts serve to deduct from the fore/aft determination due to the lack of large swings of the vehicle front end.

FIGS. 4, 4B, 4C, 4D, 4E show alternate devices for navigation and heading sensor element, 412, FIG. 3

Each of the alternate devices for navigation and heading sensor element supply the processor, 416, of FIG. 3 with heading information.

Any of orientation devices of FIG. 4, 4B, 4C, or 4D, or a several pair of INU's mounted orthogonal to each of the other pairs such as indicated on FIG. 4, are capable with suitable electronic interfaces in yielding differences in heading. Likewise to the discussion above the principal orthogonal axes of the orientation device can each determine the angle they make with the direction in which the portable wireless device is traveling by taking essentially the instantaneous difference in the two consecutive values of location as supplied by the other part of the navigation and orientation sensor 412, of FIG. 3. If the example of direction that the orientation sensor compares itself with is, for example, segment A as the portable wireless device travels towards the intersection, then the difference in direction at the point the vehicle crosses the construction line 760, is available. The difference in this angle in reference to the vector direction represented as a vector. The treatment of this direction was mentioned above. Note: there is no restriction that the angle of the turn is 90 degrees or less than 180 for that matter. This computation works equally well for computations at any angle (between direction of the A segment and direction of the E segment) other than 0 or 180.

Rear wheels won't give an indication of movement associated with radial movement of the same intensity as that of the front seat. With moderate steering inputs, front wheels can cut across the circumference lines. Rear wheels do so as well but not to the same extent. In this embodiment steadiness of radial acceleration is determined and a threshold is applied. Values that exceed the threshold are assessed as being in one of the front seats. Values less than the threshold are assessed as being in one of the rear seats.

Any of the devices of FIGS. 4, 4B, 4C, RVCG's, laser ring gyros, as well as pairs of INU's mounted orthogonal to each other, if suitably equipped with electronic interfaces offer indications of change of direction. The preferred embodiment exploits a determination of orientation from the arrangement of FIG. 4C, wherein three or more antennae elements are used to determine the orientation difference between that recently made good as determined by GNSS receiver, and that of present as determined by the change from previous by the changes in phase of the three different antennae, 408, 408′ and 408″. In one embodiment the INS is used in conjunction with any combination of the orientation entities as a stand-alone differential measurement device replacing any or all of the GNSS, or GPS element. This is optionally implemented with the device of FIG. 4F.

It is understood that for certain arrangements it is possible to have a fourth antenna. It is preferred in such installations to have the fourth antenna non-coplanar with the first three. In the preferred embodiment, analog to digital converter, (ADC) located in the navigation and orientation entity, 412, of FIG. 3, but not shown for clarity samples signal from each of the antennae. The preferred embodiment employs additional receiver paths, optionally with parallel fingers, to make an initial rough estimate of the SV/Device geometry involved for use in the more detailed RF phase comparison circuitry. Resolution of the direction of the phase is made by examination of the amplified, correlated, detected, filtered, RF curve as it is digitized in comparison to a sine wave, in conjunction with knowledge of the likely constellation diagram of the incoming signal. It is understood that where available the navigation and orientation entity will process the L1, L2, L5, L2c, E1, E2, E3 . . . signals etc, optionally with a Kalman filter for the best determination of parameters of acceleration, velocity, jerk, position, etc.

Processor, 416, of FIG. 3, performs the dot product computation of above to determine the relative angles from the principal axes of the orientation element of the navigation and orientation entity, 412, of FIG. 3.

Processor 416, has an additional thread executing, not shown, which determines the plane in which the curve of a turn in progress is located. This is done by substituting a short segment of the curve for the segment E, of FIG. 7B, or 7C. The segment is derived of the difference between recently obtained, although not the last, of consecutive values of location. This substituted into the computation for segment A in the Step S57, and/or Step S58 computations above.

By determining the angle between a recently obtained pair of consecutive values, e.g. values 4 and 5 from the last few and comparing them to the difference between the last by the taking the inverse cosine of the two most recent values and comparing the amount of heading change to a predetermined value, cases which exceed this threshold angle are assessed as an instance of front seat, use, or intended use. In some embodiments this is acted upon directly causing processor, 416, of FIG. 3 to inhibit services, send a voice message, send an SMS or text message, send a billing request, send a message to a supervisory entity's address, send an email, send a fax, or otherwise inhibit the portable wireless device. In other embodiments this is used in conjunction with an indication of left/right to make such a determination before action.

In still other embodiments instances thusly determined are signaled to the accumulation filter to indicate an instance of a front seat location, which in turn is used in conjunction with a similar accumulation filter for instances of left/right, for determinations of proximity to operator's station and acted upon inhibiting at least some services, and so on at Step S90 of FIG. 10C.

It is also understood that the determination of fore/aft is detected with more reliability at slower speeds. In some embodiments the speed as determined by the magnitude of the difference between recent consecutive values i.e. SQRT of [(delta lat)**2+(delta long)**2] is weighted inversely to offer an indication of likelihood of success in estimating fore/aft position, i.e., higher speeds are diminished in importance by processor, 416, of FIG. 3. Cases that exceed a predetermined threshold are flagged as an instance of front seat use, or intended use, and are acted upon or passed as an instance to the accumulation filter previously mentioned, which is the preferred embodiment of the fore/aft and left/right filtering, Steps S86, and S84 respectively, to the mobile wireless device inhibition function, Step S90.

In some embodiments this determination of fore/aft due to the limitations of higher speed, store the value of left right from previous slower speed.

Optionally in yet another embodiment the delay between the onset of rotational motion and the onset of linear acceleration is made. For cases of a statistically significant accumulation of essentially simultaneous onset, i.e., essentially zero delay or the linear acceleration precedes the rotational acceleration while being diminished by any cases of rotational acceleration prior to the onset of linear acceleration the circumstance is designated operator station proximal.

It is understood that numerous devices, methods and arrangements are available to make the determination of side of vehicle and to make the determination of fore/aft of the vehicle. It is understood that any of these various devices, methods, or arrangements used in any combination can be applied without deviating from the teachings of the present disclosure. Also while numerous variations on a theme are available to resolve navigational information, including location, velocity, speed, acceleration, jerk, and derived values, any of these devices, methods and arrangements are available to make the determination of use or intended use proximal to the operator's station without deviation from the teachings of this disclosure. Additionally while numerous variations on a theme are available to resolve the heading of the portable wireless device, either in essentially real time or during post processing, including in reference to any or all elements of the GNSS, other radio navigation systems, the wireless network, or any combination thereof, to make a determination of the likelihood of location fore/aft in a vehicle are available to make such a determination to be used either alone or in conjunction with any of the other determinations, to inhibit, or disable, to send messages of context of such or to be used for other determinations without deviation from the teachings of the present disclosure. For cases of both front seat and driver's seat, the portable wireless device's non-hands free capabilities are disabled. The mobile device's non-hand's free capabilities are restored after a set time at a reduced speed, e.g., two minutes at essentially zero speed. In yet another embodiment the navigational sensor is implemented with at least one of the appropriate refinements available for navigation, e.g. Differential GPS, SNAS, NSAS, CWAAS, LAAS, WAAS, BAIDOU, EGNOS, GAGAN, GALILEO, RTK, Network RTK, SBAS, etc.

FIG. 5 indicates a vehicle, in initial location.

Referring once again to FIG. 5, it is noted that as viewed from outside the vehicle, (such as in an external frame of reference) portable wireless device at location X′ is not expected to remain in the same location, or heading from the vehicle's center of turning in azimuth. During the turn, the portable wireless device, if placed on the side of the vehicle on the outside of the turn, will travel faster than the average speed of the vehicle. By accumulating a running average of the navigational information from navigation and orientation entity, a more robust determination of left or right side portable wireless device placement is made available.

Further the deduction of an increase in speed (in the external frame of reference) along the trajectory upon entry to a turn indicates portable wireless device placement on the outside of the turn, and deduction of a decrease in speed (in the external frame of reference) along the trajectory upon entry to a turn indicates portable wireless device placement on the inside of the turn.

Also deduction of a decrease in speed (in the external frame of reference) along the trajectory upon exiting from a turn indicates portable wireless device placement on the outside of a turn, and deduction of an increase in speed (in the external frame of reference) along the trajectory upon exit indicate portable wireless device placement on the inside of a turn.

When each of these is taken in conjunction with the direction of turn, taken from the orientation entity, or in an alternate embodiment, kept track of and compared in a post processing fashion by processor, portable wireless device placement is determined to be on one side of the vehicle or the other, i.e., if the portable wireless device is determined to be on the inside of the turn and that the turn was to the left, deduces an instance of portable wireless device placement on the left side of the vehicle, and vice versa.

It is also noted that provided a network settable parameter indicates the side of the road that the adjunct device described will determine whether the portable wireless device is being used/attempted to be used on the driver's side of the vehicle.

As was seen in the discussion following FIG. 5, a discussion of methods to refine the latitude and longitude exist. By extrapolating perceived velocity and direction, reasonably accurate values for velocity and direction are obtained. This is optionally performed for regular geometric shapes, e.g. line, curve, parabola, arc of a circle, etc. Although functional without, this technique is optionally applied by post processing. Locus of the portable wireless device is recorded. Least squares curve fitting is then performed on the data. Once the curve fitting has begun, incoming data are compared against the extrapolated shape permitting precision of location, although not necessarily accuracy. Accuracy of navigation, e.g., for GNSS, or GPS, although used is not necessarily a requirement. Accuracy of acceleration is important.

With very good indications of velocity from the navigation entity, 412, of FIG. 3 and direction from the orientation entity, 412′ of FIG. 3 the processor of FIG. 3, filters the acceleration profile at the beginning and exit of definite turns and compares resultant values to those of what were essentially straight stretches offering advantageous filtering out of the undesired wavering and motion of essentially straight stretches of travel. Motions that are sustained over an optional interval are used to qualify turns that are occurring, or those that have occurred from the set of all turns.

In alternate arrangements acceleration signals, or differences in velocities of satellite or cell phone tower pseudo ranges, in known directions from the user, are used to make estimates of differences in the acceleration profiles.

Returning to the discussion of FIGS. 5B and 5C, it is noted that although the portable wireless device trajectory may follow an arc of the same radius, placement on the left or right side of a vehicle are discernable from indications in the vehicle velocities as the vehicle leaves the turn, or as the vehicle enters the turn.

Portable wireless device placement is discerned to be on the inside of the turn, or the outside of the turn, when taken in comparison to vehicle speeds, in the direction of the longitudinal vehicle axis, pre and post the turn, and that when taken in conjunction with an indication of the direction of the turn, deductions of the particular side of the vehicle that the portable wireless device is placed are usable to adjust services.

During turns to the left, as the portable wireless device speeds up, or slows down, is most closely associated with the beginning of a right turn, left turn, or the end of a right turn, or left turn. Rate gyro, information to be later discussed will offer an indication of whether the turn is to the right or the left, and whether the turn is beginning or ending, Indications of whether the portable wireless device is on the left or right side of the vehicle are deduced. When taken in conjunction with an indication that the portable wireless device network is in jurisdictions taken to use right hand drive vehicles, or left hand drive vehicles, instances of operator use, or intended use can be deduced, accumulated, or otherwise used.

Referring once again to FIGS. 6 and 6B, processor, 416, of FIG. 3, tracks and extrapolates the velocity profile. Rapid deviations from the extrapolated profile in plan form are assessed as turning motion. Used in conjunction with the direction of turn as determined by comparing the present portable wireless device position subtracting the previous portable wireless device location, processor, 416, determines the most plausible side of the vehicle that the portable wireless device is situated in. By accumulating this in a running average of many such instances and deducting from this any instances wherein the processor, 416, of FIG. 3, determines that the operation, or intended operation was other than proximal to the vehicle's operator's station, a typical deceleration profile is added to corroboratory information accumulated in the processor memory, 414, of FIG. 3. An additional consideration is that the detector, which detects the deviation from the extrapolated deceleration in preparation for a turn can be reset and prepared for another acceleration profile in this case positive as the vehicle leaves the turn and begins accelerating. The reset is actuated by a uni-polarity indication of jerk, as shown in the jerk graph on the lower half of FIG. 6B, and as determined at Step S32 of FIG. 10. From the determination made at Step S57, of FIG. 10B, it is understood that a portable wireless device when decelerating is expected to undergo a turn and ultimately acceleration, will undergo a change of sign, as opposed to a short interval of acceleration different from present, without a continuation of the velocity function of essentially the same direction, i.e., the velocity will be expected to make a shift during a single deceleration at the onset of turning. We see this in the jerk, and acceleration profiles shown in FIG. 6B. Likewise the portable wireless device is expected to make a shift at the removal of the steering input as the vehicle leaves the turn, however there is a fundamental shift in the direction of the velocity function occurring once per typical turn. In all embodiments non-typical values detected by multiple curves, S-turns, or like, are filtered out of the turns under consideration based on the indications from Step S57, of FIG. 10B.

Use of any kind above a threshold speed necessitates use of non-hands free mode. This is detected by a simple plug detector jack used in place of the usual simple jack, or connector, or by sensing the current as described in the description pertaining to FIG. 3. The preferred example, executing processing steps, S84 and S86 of FIG. 10C, determine operator location cases. For cases of statistically more operator's side and statistically more front seat operation, or intended operation the processor of FIG. 3, 416 ascertains that this is either operator operation or operator intended operation at Step S88 of FIG. 10C. The processor signals the portable communications entity 422, FIG. 3, to inhibit activities, at step S90, of FIG. 10C.

A further thread inhibits the portable apparatus, above a system parameter speed unless it is being used in other than hand-free fashion, as determined by sensing current going to/from the headset as indicated by voltage between, analog inputs DET1 and DET2. This thread is not shown for clarity.

It is noted that motion in the rear seat is more similar to that of the center of rotation than device locations closer to the vehicle front. Motion in the front seat has a lateral motion associated with it. This is particularly apparent at slower speeds and/or tighter larger steering inputs.

The comparison between the local heading as determined by GNSS differences and the local acceleration as determined by measurement element give an indication of location within the vehicle in the fore/aft sense.

FIG. 7B has roadway 780 with an approach to intersection A, and line of travel away from intersection, E.

Complementary to the method of FIG. 6, the method described in the discussion of FIGS. 7B, 7C, 7D, and 7E teaches that by carefully tracking the in-road, and the out-road to a given intersection or point of turn in an otherwise straight stretch of roadway, processor, 416 deduces the half way point of the turn. Examinations of the heading of the portable wireless device found to be different from 90 degrees in azimuth from the turn halfway point, an instance of whether the portable wireless device is deemed to be in the front or the back is made. This instance is used directly in some embodiments. In other embodiments, the instance is added to a running average, and subtracted from the running average for cases deduced but not found to be in the front of the vehicle.

FIG. 8 shows an exemplary curved trajectory over which a portable wireless device travels for extraction of instances of the portable wireless device use/intended use in the front/back of a vehicle. This is complementary to the discussion of FIG. 6B, but also optionally a substitute to the method of the discussion of FIG. 6B.

The discussion of FIG. 8 teaches that lateral movement away from the a previous average path, that exceeds a threshold for such permits extraction of cases of front seat use from all portable wireless device use cases.

Referring to FIG. 9 is shown an optional method for determination of portable wireless device placement in a vehicle complementary to that of the method described in FIG. 6B, and that of the method described in FIG. 7B, 7C, 7D, 7E, and complementary to the discussion of FIG. 8. This method makes use of the refined method of Differential GPS, with WAAS, LAAS, SBAS, or those of processing block 388 of FIGS. 3 and 3C.

In this alternate embodiment, the device of FIGS. 3 and 3C incorporate in memory 414, data corresponding to locations of relative lanes that are essentially parallel, wherein knowledge of portable wireless device passage as would be along such lanes permits a difference of velocity, or optionally displacement to be made permitting a deduction about the location of the portable wireless device in a vehicle. The longer the distance in this case the greater chance that the user is in the left seat and in the case of locations where left hand operator's positions are prevalent an indication that the user is on the left side of the vehicle and is made available to be used with an indication of fore/aft permitting a deduction of use, or intended use proximal to the operator's station is made, and the user's equipment is at least partially inhibited based on such information.

The inclusion of a small database containing velocity, and optionally displacement details of vehicle trajectories permits an alternate method of detection of position within the vehicle. In another embodiments lane data is available from a rough indication of the location of the vehicle, i.e., the vehicle determines its position sends this to a network receives exact information about where the lane is back to the vehicle over a network.

It is an aspect of this disclosure that there are several different correlators of this nature that process the codes of the respective SV and do so at the speed appropriate commensurate the SV's Doppler shift, which can amount to approximately ±5 KHz, offering a further refinement of the navigation location of the portable wireless device suitable for determinations of location in the traffic lane. Examination of FIG. 10C shows that traces of the rear wheels are different than that of the front wheels. Placement of the portable wireless device more proximal to the rear wheels exhibits more of a trace similar to that of pure rear wheel motion. Placement of the portable wireless device more proximal to the front wheels exhibits more of a trace similar to that of pure front wheel motion.

By storing the set of four templates previously mentioned, and correlating against an assessment of the differences from ideal and ascertaining if the motion is more of a front motion rather than a rear initiates an instance of operator's location fore/aft or a contraindication either for direct use, or as input to the running average determination of such that is made at Step S16, of FIG. 10.

In another embodiment profiles of the mobile device's motion are compared against known motion profiles for front, rear, left, right locations.

In yet another embodiment the profiles are retrieved from a store of known profiles recalled based on known position from a navigation database, i.e., Interstate 90 has a gentle long curve that has known radii of curvature per lane, is the user on the driver's side of the vehicle or the passenger's side?

In yet another embodiment this data is retrieved from a network in essentially real time.

It is an aspect of this disclosure that the difference between the family of trajectories related to position information associated with the left side of the vehicle are discerned from the family of trajectories related to the position information related to the right side of the vehicle and acted upon based on the results.

It is an aspect of the disclosure that the difference between the family of trajectories related to position information associated with use, or intended use, in the rear part of the vehicle is discerned from family of trajectories related to position information related to the operation, or intended operation, in the front part of the vehicle and acting upon this determination.

It is an aspect of this disclosure that the composite discernment is acted upon, said discernment being the composite determination of the previous two claims.

It is an aspect of the present disclosure that, using known information, e.g., the left/right position in the vehicle that the fore/aft information can be determined/augmented, by resolving the location at which a vehicle may come to a stop. This is discussed in detail in patent application US20070263779.

Discussion of FIG. 9 teaches us that any first order time differential of displacement can be used for velocity for certain embodiments.

The discussion of the optional method of FIG. 9B, complementary to those previous, teaches a method for making a determination of portable wireless device vehicle placement in the left/right sense. In this optional method knowledge of map culture is compared to location in lane that a vehicle must be in to yield such parameters of distance, or location.

It is an aspect of the present disclosure that comparisons of trajectories of a given location in lane are made based on the trajectories associated with location in lane associated with the best match trajectory, i.e., for turns from a given lane position to the same lane position (i.e., left of center, or right of center of lane) in a lane at other than 180 degree angles the arrangement determines that for a given profile of such a turn that the location of the portable device in the vehicle most plausibly was one of being in the operator's location, or that of not being in the operator's location.

The discussion of FIG. 9C teaches a method, complementary to any of the previous for determining placement in a vehicle of a portable wireless device in the left right sense. In this alternate embodiment, the device of FIG. 3 incorporates in memory, 414, data corresponding to the relative location in a vehicle at a stop line relative to a position left/right in a vehicle as it leaves the intersection can be made. The direction of travel is determined by subtracting former locations from the present location. The direction of travel leading away from the intersection is determined by similar exercise. The relative angle between these two roadways is determined by any suitable method, such as converting the lat/long information, taking the cross product of the approach and exit from the intersection.

From the determination of distance from the stop line to the roadway leading away from the intersection, provided an indication of left/right is available a priori, a determination of distance is made wherein the distance is attributed to the user being in the rear seat or the front seat. Alternatively, a priori knowledge of the location fore/aft in the vehicle can be used in conjunction with a priori knowledge of the location of the stop line available in memory or via network, to determine the location in the lane and by extension the location left/right in the vehicle. This technique works well for intersection elements that are other than 90 degree to each other as well.

It is also noted that use of deductions about vehicle location at a stop line can be converted for use to complete the picture of portable wireless device placement in a vehicle, and vice versa.

It is an aspect of the disclosure that a differentiation between use/intended use, in the vehicle left/right sense is made and acted upon for the purposes of inhibition of mobile services.

It is understood that filters suitable to remove any irregular vehicle motion are optionally implemented to prevent difficult to analyze trajectories from swamping the running averages. In this fashion certain attributes of a trajectory are used to eliminate irregular trajectory vestiges. It is also understood that several different types of trajectory and trajectory/orientation combinations are filtered for and permitted for assessment by the processor.

It is understood that many different methods of filtering the incoming velocity and heading signals are able to be done and remain within the context of the disclosure.

Other threads, not shown for clarity, include determination of when a turn has been made, i.e. a shift in the heading of more than a fixed number of degrees, whereupon the determination of a turn thread triggers a test or post processing to make a determination of fore/aft, or left/right, for inclusion in any of the using elements of such information, i.e. a running average accumulator, or use outright in the determination of such.

FIG. 11, shows an arrangement, alternate to that previously described for extraction of motion information is depicted.

From the previous discussion of how the various elements of FIG. 11 interact, it can be seen that alternate arrangements exist permitting satellite location to be deduced by directional antennae on the receiver. From this information and techniques such as resolution of the velocity between the user and the satellite as per either FIG. 3D or FIG. 3E, with, or without, DGPS, very fine movements are tracked. Examination of the subtleties of theses movements permit indications of portable wireless device movement more indicative of proximity to left side, or right side of vehicle. It is understood that these are used in conjunction with information pertaining to vehicle fore/aft determinations and absent any reason not to inhibit portable wireless device use, (such as fire, police, ambulance, delivery vehicle), a change in services is effected, or a service delivered.

The embodiment of FIG. 11B is an alternate to that of FIGS. 3 and 11, and complementary to that of FIG. 11.

From the former discussion of FIG. 11B, it will be noted that an arrangement exists permitting use of the horizontal component of user velocity for use by the processor for deducing that a portable wireless device is being used/about to be used in the operator's station in a vehicle. Using the local level, the component of the relative speeds between the user and the satellite's Doppler shifts, very accurate estimates of the user's velocity are deduced. By tracking this when this is available from more than two satellites, an indication of the velocity of the user becomes available. By integrating the Doppler value of FIG. 3D, very accurate user velocity is available to processor 416, of FIG. 3, and is used by any of the methods discussed in this disclosure for determination of use/intended use proximal to the operator's station.

FIG. 10D teaches how refinements of latitude, longitude or both are done.

FIG. 12 teaches an arrangement for simple modification of a cell phone and its battery. In this embodiment, complementary to any combination of those that have been discussed, we are taught an arrangement that is not onerous on cell phone manufactures with a very minor change to the cell phone plastic in the vicinity of the cell phone's battery, or battery wiring.

In this arrangement the battery packaging is mechanically keyed to fit into battery compartment 430 of the portable wireless device, 422.

This arrangement has a portable wireless device battery compartment with a keyway operable to prevent the installation of a common portable wireless device battery lacking the appropriate key. Some arrangements mechanically preclude connection to the portable wireless devices electrical contacts.

In some embodiments the battery is not only equipped with the adjunct device, but also equipped with the inertial sensor of FIG. 4F, with additional on battery circuitry to permit a temporary awakening of the processor, navigation, orientation entities, and inhibition circuitry and execution elements of the methods discussed in this disclosure, based on a fixed time interval that is network settable. This permits an easy implementation path for the cell phone manufacturers and cell phone carriers.

In some embodiments this keying is electronic. In the electronically keyed portable wireless devices the keying is such that they will not turn on without a communication from a small key sequence generating element, not shown, but considered part of the battery/inhibiting arrangement, electrically connected to one of: the battery, separate connections, or a combination of both, operable to authenticate, the presence of, at least one of the arrangements of the present disclosure.

In this embodiment this implementation disables the mobile unit's power supply.

In this embodiment the device with an integral GPS chip, GPS antenna, orientation entity, and fixed inertial element, of FIG. 4F, is located integrally with the battery in the usual volume that a battery occupies, with the same connections external to the battery that the portable wireless device battery has.

The discussion of the arrangement of FIG. 12, uses a mechanical keyway, 430 operable to exclude batteries that have not been suitably modified. Overall battery compartment, 430, accepts only suitably modified batteries. In another embodiments, alternate to the mechanical keying, is shown via the optional path output from processor, 416, port OUT′ where an authentication signal is output informing the portable wireless device, 422, that this is an authentic battery with the driver proximity safety element, implementing at least one of the embodiments of the present disclosure. In another embodiment, the mechanical keyway ramifications, i.e. keying in battery, and keyway in battery location in overall portable wireless device are not present if the electronic keying just mentioned is extant.

In another embodiment of the present disclosure, the disabling function is integral to a mobile device battery.

In another embodiment, the inhibition of services upon detection of, at least intended, operation proximal to the operator's station is rescinded for Emergency Medical Services, Fire, Police, First Responders, and Taxi use.

In another embodiment, the inhibition of services upon detection of, at least intended, operation proximal to the operator's station is rescinded for cases of detection context sending of sufficient fidelity as to inform other parties to the communication as to the conditions of usage.

It is understood that any combination, of any or all of the above techniques, used in any measure, are understood to be part of the present disclosure, and are optionally used in conjunction with any combination or all of the inhibitions taught in the present disclosure. It is understood that Precise Positioning is able to replace any or all of the techniques of refinement of position without deviating from the present disclosure.

### Cutout for Public Transit Use

It is an option of any of these embodiments that motion on a train, ship, or aircraft is determined by determining that the jerk or first time differential of motion is below a threshold. This is calculated by taking the successive time differentials of the position, or speed as appropriate and deducing the jerk, comparing this to a threshold and permitting the use of the service provided that the jerk is below this (network enabled, or otherwise constant) jerk threshold. It is an option of any of these embodiments to likewise make a azimuthally determined heading change and permitting use provided the value is below an acceptable value an indication of motion on a train, ship or aircraft, unlike terrestrial vehicles in the land family with a larger jerk, and quicker azimuth changes.

In yet another aspect of the present disclosure a threshold beyond those presently established for discerning operator use is exploited, i.e., signals so processed must exceed those that could be associated with use, or intended use, in the operator's position in a vehicle. It is an aspect of this disclosure that a different threshold may exist for the fore/aft determination than that for the left/right determination. It is an optional aspect of the present disclosure that left/right and fore/aft threshold exceedance values are network provided.

It is understood that although example turns are predominantly to the right, similar arguments exist for turns to the left and are hereby incorporated into the present disclosure.

In another embodiment of the present disclosure, all circuitry of item 417, of FIG. 5 is contained internal to the portable wireless device. In some embodiments this is integral to integrated circuitry of the portable wireless device.

It is an aspect of the present disclosure to use an indication of jerk and an indication of azimuth change rate to permit use of the unit provided the speed is above a certain threshold.

It is understood that at any location in the present disclosure where GPS is used, it is permissible to use GNSS in place without deviating from the meaning of the disclosure.

It is an aspect of the present disclosure that multi-path mitigation techniques may be applied to any combination of the previous and subsequent embodiments. It is an aspect of this disclosure that detected jumps in position due to multi-path, fades or otherwise, are rejected from incorporation in running averages by the processor.

In an alternate embodiment of this disclosure, at least some information is passed from Step to Step in objects.

It is also understood that this optionally uses at least part of any of the alternate systems and remain within the present disclosure. It is understood that the present disclosure is optionally, at least partially implemented in the form of computer-implemented processes and various processing arrangements for practicing these, at least one, processes. Subject elements present disclosure can be embodied in the form of processor program code containing instructions in tangible means, such as PROM, RAM, EPROM, EEPROM, FLASH, CORE, DISC, or other readable storage entities, located on the movable element or not, wherein the executing entity, or executing arrangement becomes an arrangement for practicing the invention when the code is loaded into, or otherwise executed, at least partially on such processing arrangement(s). Regardless of the mechanism for presenting, at least part of, the code to the processing arrangement, beit wired, fibreoptics, or wirelessly, optically, IR, ultrasonic or otherwise, when the computer code is loaded into and, at least partially executed, by the processing arrangement, the processing means becomes an arrangement for practicing the invention. When implemented on a general purpose processing means, the computer code segments configure the processing means to create specific logic circuits.

Obviously, many modifications and variations of the present invention are possible in light of the above teachings. It is therefore to be understood that within the scope of the appended claims, the invention may be practiced otherwise than as specifically described.

1. An arrangement for portable wireless device service change based on deduced presence proximal to vehicle operator's station, wherein at least one of velocity, acceleration, jerk, speed, displacement as determined from at least partial information from a navigation system.

2. The arrangement of claim 1, wherein said navigation system is at least one of: GNSS, GPS, GAGAN, GLONAS, WAAS, LAAS, DGPS, DGNSS, SBAS, RTK, Network RTK, EGNOS, GALILEO, BAIDOU, INS, Kalman filter, Cell phone network, Wifi hotspot, Wimax hotspot, radio navigation source.

3. The arrangement of claim 1 wherein service change is based on at least one side-of-vehicle instance of portable wireless device presence.

4. The arrangement of claim 1 wherein service change is based on at least one fore/aft instance of portable wireless device presence

5. The arrangement of claim 3 and claim 4.

6. The arrangement of claim 3 wherein proximity to operator's station is assessed statistically washing out the number of successful instances in ratio to unsuccessful instances of such.

7. The arrangement of claim 4, wherein proximity to operator's station is assessed statistically washing out the number of successful instances in ratio to the number of unsuccessful instances of such.

8. The arrangement of claim 6 and claim 7.

9. The arrangement of claim 1, wherein the service change is an inhibition

10. A method of ascertaining proximity to a vehicle's operator's station comprising: a radio navigation entity, an orientation entity, a processor operable to make a statistical estimation indicative of portable wireless device located on driver's side of vehicle based on compared portable wireless device speeds, said processor operable to make a further statistical estimation indicative of portable wireless device proximity to the vehicle front based on orientation differences, said processor further operable to change mobile services as a consequence of detecting portable wireless device proximal to said operator's station.

11. The method of claim 10 wherein the statistical estimation value is diminished for estimations contrary to driver's seat proximity.

12. The method of claim 11 wherein to change mobile services further comprises:
adjusting portable wireless device use based on proximity to vehicle operator's station, using at least one of:
exchange of left/right deductions for fore/aft deductions,
portable wireless device placement in lane,
known map culture features,
comparison with a stored scaleable version of lane change information scaled to that sensed by said portable wireless device.

13. A device for inhibiting a portable wireless device detected to be proximal to operator's station based on changes in orientation, and speed of vehicle longitudinal axis trajectory

14. The device of claim 13 wherein the portable wireless device above a velocity indicative of vehicular motion, wherein said inhibition is at least one of: hands-free aspects of the device, Bluetooth aspects of the device, a local area network of the device,

15. The arrangement of claim 2, wherein the ascertainment is based on a running average, said running average being diminished for each instance of portable wireless device operation proximal to vehicle operator's station, said running average further comprising orientation comparison being diminished by ascertainments of forward vehicle location information exceeding a threshold parameter value.

16. The arrangement of claim 15 wherein portable wireless device inhibition comprises: a keyed battery, a keyed battery compartment operable to accept said keyed battery, a navigation element operable to resolve the difference in portable wireless device speed, an orientation element, a processor, said processor operable to ascertain a running average of instances indicative of operator's vehicle side, said processor further operable to ascertain, from navigation element supplied information and orientation element supplied information, proximity to vehicle front and to thereby remove power from the battery to the portable wireless device.

17. A device for inhibiting a portable wireless device comprising: a navigation element, an orientation element, a processor in communication with said navigation element, said processor further in communications with orientation element and operable to make a determination of left/right vehicle side location based on changes in integrated Doppler as accumulated from GNSS carrier tracking information.

18. The device of claim 17 wherein the navigation element further comprises a differential GNSS element that is at least one of: GPS, GNSS, DGPS, DGNSSS, GLONAS, COMPAS, GAGAN, WAAS, LAAS, SBAS, GBAS, RTK, Network RTK.

19. The device of claim 22 wherein the orientation element is at least one of: tuning fork, rate gyro, RVCG, Laser Ring Gyro, an assessment of RF phase differences from different portable wireless device antennae

20. The arrangement of claim 1 wherein the navigation element is further comprised: an inertial element to track position

21. The arrangement of claim 1, wherein the navigation element is supplemented with an acceleration threshold detection element operable in conjunction with said processor to ascertain accelerations indicative of vehicle inclusion and a routine to cause the navigation and orientation function to be used only for three minute intervals after detection of a suitable level acceleration.

22. The arrangement of claim 1 wherein a network settable parameter is used to differentiate at least one of: emergency use, right hand drive use, left hand drive use.

23. The arrangement of claim 1 wherein the assessment of curvature is filtered for regular shaped trajectories and rejects other shaped trajectories
